(19) United States
(12) Patent Application Publication
(10) Pub. No.: US 2024/0298247 A1
(43) Pub. Date: Sep. 5, 2024

(54) Multi-Link Communication Method, Apparatus, and Readable Storage Medium

(71) Applicant: Huawei Technologies Co., Ltd., Shenzhen (CN)

(72) Inventors: Guogang Huang, Shenzhen (CN); Ming Gan, Shenzhen (CN); Yuchen Guo, Shenzhen (CN); Yunbo Li, Shenzhen (CN)

(21) Appl. No.: 18/663,276

(22) Filed: May 14, 2024

Related U.S. Application Data
(63) Continuation of application No. PCT/CN2022/128924, filed on Nov. 1, 2022.

(30) Foreign Application Priority Data
Nov. 15, 2021 (CN) 202111350969.8

(51) Int. Cl. H04W 48/02; H04W 28/02; H04W 60/04

(52) U.S. Cl. CPC H04W 48/02; H04W 28/0268; H04W 60/04

(57) ABSTRACT

A multi-link communication method is implemented by an access point (AP) multi-link device (MLD). The multi-link communication method includes generating a first frame, and sending the first frame on a first link. The first frame includes a supported rates and a basic service set (BSS) membership selectors element, the element includes first indication information, and the first indication information indicates that a non-AP MLD is disallowed to initiate multi-link setup with the AP MLD on the first link.

### CROSS-REFERENCE TO RELATED APPLICATIONS

This is a continuation of International Patent Application No. PCT/CN2022/128924 filed on Nov. 1, 2022, which claims priority to Chinese Patent Application No. 202111350969.8 filed on Nov. 15, 2021. The disclosures of the aforementioned applications are hereby incorporated by reference in their entireties.

### TECHNICAL FIELD

The present disclosure relates to the field of wireless communication technologies, and in particular, to a multi-link communication method, an apparatus, and a readable storage medium.

### BACKGROUND

A wireless local area network (WLAN) has been developed for many generations, including 802.11a/b/g, 802.11n, 802.11ac, 802.11ax, and 802.11be that is being under discussion. The 802.11be standard is also referred to as an extremely high throughput (EHT) standard, Wi-Fi 7, or the like.

A low latency is an important feature of the 802.11be standard. In the 802.11be standard, a packet delay may be reduced through a multi-link and traffic identifier (TID)-to-link mapping and an access point (AP) is further allowed to set up a restricted target wake time (TWT) for transmitting a low-latency service to reduce interference of another service to the low-latency service, thereby reducing a delay of the low-latency service.

To better support transmission of the low-latency service, a new TID-to-link mapping capability indication, referred to as enhanced link subset mapping is proposed. For the enhanced link subset mapping, an AP multi-link device (MLD) broadcasts a TID-to-link mapping scheme, where some links allow only TID data corresponding to the low-latency service to be sent on the links, and other links allow TID data corresponding to all services to be sent on the other links. For example, it is assumed that the AP MLD has three links: a link 1, a link 2, and a link 3, and a TID 6 and a TID 7 are TIDs used by low-latency services. The AP MLD may broadcast a TID-to-link mapping scheme shown in Table 1 (a symbol “✓” in Table 1 may indicate that mapping is allowed, and a symbol “X” may indicate that mapping is not allowed.). The link 3 allows only a TID corresponding to a low-latency service to be mapped to the link, and therefore the link 3 is referred to as a clean link. However, how to set up a link (namely, a clean link) to which only a TID corresponding to a low-latency service is allowed to be mapped, to prevent the low-latency service on the link from being interfered by a non-low-latency service is not resolved.

TABLE 1

| | TID | TID | TID | TID | TID | TID | TID | TID |
|---|---|---|---|---|---|---|---|---|
| | 0 | 1 | 2 | 3 | 4 | 5 | 6 | 7 |
| Link 1 | ✓ | ✓ | ✓ | ✓ | ✓ | ✓ | ✓ | ✓ |
| Link 2 | ✓ | ✓ | ✓ | ✓ | ✓ | ✓ | ✓ | ✓ |
| Link 3 | X | X | X | X | X | X | ✓ | ✓ |

### SUMMARY

Embodiments of the present disclosure provide a multi-link communication method, an apparatus, and a readable storage medium, to prevent a low-latency service on a link (namely, a clean link) to which only a TID corresponding to the low-latency service is allowed to be mapped from being interfered by a non-low-latency service.

The following describes the present disclosure from different aspects. It should be understood that the following implementations and beneficial effect of the different aspects may be mutually referenced.

According to a first aspect, the present disclosure provides a multi-link communication method. The method includes: An AP MLD generates a first frame, and sends the first frame on a first link, where the first frame includes a supported rates and basic service set (BSS) membership selectors element, the supported rates and BSS membership selectors element includes first indication information, and the first indication information indicates that a non-AP MLD is disallowed to initiate multi-link setup with the AP MLD on the first link. The AP MLD has at least two links, and the at least two links include the first link and a second link. The first link is a link on which only a low-latency service is allowed to be transmitted or a link to which only a TID corresponding to a low-latency service is allowed to be mapped, that is, the first link is a clean link.

It should be understood that, if the non-AP MLD initiates multi-link setup through the clean link, it is possible that the non-AP MLD successfully sets up only the link (namely, the clean link) with the AP MLD. In this case, the non-AP MLD may have the low-latency service and a non-low-latency service on the link. Therefore, the link cannot be used to transmit only the low-latency service. Therefore, in this solution, the indication information is carried in the supported rates and BSS membership selectors element, to indicate that the non-AP MLD is disallowed to initiate multi-link setup on the clean link, and the non-AP MLD needs to set up the link through another link of the AP MLD, to prevent a case in which only the clean link is successfully set up between the non-AP MLD and the AP MLD, to further prevent the low-latency service on the clean link from being interfered by the non-low-latency service.

With reference to the first aspect, in a possible implementation, the method further includes: The AP MLD sends a beacon frame or a probe response frame on the second link, where the beacon frame or the probe response frame includes a reduced neighbor report element (RNR element), the RNR element includes a neighbor AP information field corresponding to a first AP, a channel number field in the neighbor AP information field is set to 0, and the first AP is an AP operating on the first link in the AP MLD.

In this solution, the channel number field corresponding to the first AP in the RNR element is set to 0, so that a legacy STA cannot discover the first AP by using the RNR element, and does not switch to a corresponding channel to attempt association. In this way, the low-latency service on the clean link is not interfered by the non-low-latency service.

The “legacy STA” in the present disclosure is a station supporting only a protocol earlier than an 802.11be protocol, for example, an HE station supporting an 802.11ax protocol, a VHT station supporting an 802.11ac protocol, or an HT station supporting an 802.11n protocol.

With reference to the first aspect, in a possible implementation, when the first frame is an association response frame or a reassociation response frame, the first frame further includes a quality of service (QOS) map element, where the QoS map element includes respective differentiated services code point (DSCP) range fields corresponding to eight different user priorities; DSCP ranges indicated by DSCP range fields corresponding to m user priorities in the eight different user priorities (0 to 7) cover DSCP space; and DSCP low value fields and DSCP high value fields in DSCP range fields corresponding to remaining (8−m) user priorities in the eight different user priorities are all set to 255. m is a positive integer less than 8, and the DSCP space is an interval [0, 63].

The user priority and the TID are not distinguished in the present disclosure. There is a one-to-one correspondence between the user priority and the TID, and the user priority and the TID may be used alternatively in the present disclosure.

In other words, DSCP ranges indicated by DSCP range fields corresponding to all TIDs in a first TID set in the QoS map element cover the entire DSCP space, namely, the interval [0, 63]; and DSCP low value fields and DSCP high value fields in DSCP range fields corresponding to all TIDs in a second TID set are all set to 255. The first TID set includes one or more TIDs, and the second TID set includes one or more TIDs. A union set of the first TID set and the second TID set is TID space, in other words, 0, 1, 2, 3, 4, 5, 6, and 7. The TIDs in the first TID set are used to identify non-low-latency services, and the TIDs in the second TID set are used to identify low-latency services, or only the AP MLD is allowed to map a stream classification service (SCS) stream successfully added according to an SCS mechanism to the second TID set.

In this solution, the TID space (0 to 7) is divided into two parts by using the QoS map element. One part is used for non-low-latency services, and the other part is used for low-latency services. Whether a corresponding medium access control (MAC) protocol data unit (PDU) (MPDU) is low-latency service data or non-low-latency service data may be distinguished by using a TID, in other words, a low-latency service and a non-low-latency service are not mapped to a same TID.

With reference to the first aspect, in a possible implementation, the method further includes: after the AP MLD sends the first frame on the first link, the method further includes: The AP MLD receives a SCS request frame, where the SCS request frame includes an SCS identifier field, and the SCS identifier field indicates a reported SCS stream. The AP MLD sends an SCS response frame, where the SCS response frame includes a status code field, and the status code field indicates whether the AP MLD accepts the SCS stream.

Optionally, when the status code field indicates that the AP MLD accepts the SCS stream, the SCS response frame further includes a TID-to-link mapping element, and the TID-to-link mapping element indicates a TID mapping rule.

In this solution, traffic identifier (TID)-to-link mapping negotiation is performed according to the SCS mechanism. This can reduce signaling overheads.

With reference to the first aspect, in a possible implementation, the method further includes: The AP MLD sends a data packet, where a TID of the data packet is set based on the QoS map element when the data packet does not match the SCS stream, or a TID of the data packet is set based on the TID-to-link mapping element carried in the SCS response frame when the data packet matches the SCS stream.

According to a second aspect, the present disclosure provides a multi-link communication method. The method includes: A non-AP MLD receives a first frame on a first link, and parses the first frame. The first frame includes a supported rates and BSS membership selectors element, the supported rates and BSS membership selectors element includes first indication information, and the first indication information indicates that the non-AP MLD is disallowed to initiate multi-link setup with an AP MLD on the first link. The first link is a link on which only a low-latency service is allowed to be transmitted or a link to which only a TID corresponding to a low-latency service is allowed to be mapped, that is, the first link is a clean link.

With reference to the second aspect, in a possible implementation, the method further includes: The non-AP MLD receives a beacon frame or a probe response frame on a second link, where the beacon frame or the probe response frame includes an RNR element, the RNR element includes a neighbor AP information field corresponding to a first AP, a channel number field in the neighbor AP information field is set to 0, and the first AP is an AP operating on the first link in the AP MLD.

With reference to the second aspect, in a possible implementation, when the first frame is an association response frame or a reassociation response frame, the first frame further includes a QoS map element, where the QoS map element includes respective DSCP range fields corresponding to eight different user priorities; DSCP ranges indicated by DSCP range fields corresponding to m user priorities in the eight different user priorities (0 to 7) cover DSCP space; and DSCP low value fields and DSCP high value fields in DSCP range fields corresponding to remaining (8−m) user priorities in the eight different user priorities are all set to 255. m is a positive integer less than 8, and the DSCP space is an interval [0, 63].

With reference to the second aspect, in a possible implementation, after the non-AP MLD parses the first frame, the method further includes: The non-AP MLD sends an SCS request frame, where the SCS request frame includes an SCS identifier field, and the SCS identifier field indicates a reported SCS stream. The non-AP MLD receives an SCS response frame, where the SCS response frame includes a status code field, and the status code field indicates whether the AP MLD accepts the SCS stream.

Optionally, when the status code field indicates that the AP MLD accepts the SCS stream, the SCS response frame further includes a TID-to-link mapping element, and the TID-to-link mapping element indicates a TID mapping rule.

With reference to the second aspect, in a possible implementation, the method further includes: The non-AP MLD sends a data packet, where a TID of the data packet is set based on the QoS map element when the data packet does not match the SCS stream, or a TID of the data packet is set based on the TID-to-link mapping element carried in the SCS response frame when the data packet matches the SCS stream.

According to a third aspect, the present disclosure provides a communication apparatus. The communication apparatus may be an AP MLD or a chip in an AP MLD, for example, a Wi-Fi chip. The communication apparatus includes: a processing unit configured to generate a first frame, where the first frame includes a supported rates and BSS membership selectors element, the supported rates and BSS membership selectors element includes first indication information, and the first indication information indicates that a non-AP MLD is disallowed to initiate multi-link setup with the AP MLD on a first link; and a transceiver unit configured to send the first frame on a first link. The AP MLD has at least two links, and the at least two links include the first link and a second link. The first link is a link on which only a low-latency service is allowed to be transmitted or a link to which only a TID corresponding to a low-latency service is allowed to be mapped, that is, the first link is a clean link.

With reference to the third aspect, in a possible implementation, the transceiver unit is further configured to send a beacon frame or a probe response frame on the second link, where the beacon frame or the probe response frame includes an RNR element, the RNR element includes a neighbor AP information field corresponding to a first AP, a channel number field in the neighbor AP information field is set to 0, and the first AP is an AP operating on the first link in the AP MLD.

With reference to the third aspect, in a possible implementation, when the first frame is an association response frame or a reassociation response frame, the first frame further includes a QoS map element, where the QoS map element includes respective DSCP range fields corresponding to eight different user priorities; DSCP ranges indicated by DSCP range fields corresponding to m user priorities in the eight different user priorities (0 to 7) cover DSCP space; and DSCP low value fields and DSCP high value fields in DSCP range fields corresponding to remaining (8−m) user priorities in the eight different user priorities are all set to 255. m is a positive integer less than 8, and the DSCP space is an interval [0, 63].

With reference to the third aspect, in a possible implementation, the transceiver unit is further configured to: receive an SCS request frame, where the SCS request frame includes an SCS identifier field, and the SCS identifier field indicates a reported SCS stream; and send an SCS response frame, where the SCS response frame includes a status code field, and the status code field indicates whether the AP MLD accepts the SCS stream.

Optionally, when the status code field indicates that the AP MLD accepts the SCS stream, the SCS response frame further includes a TID-to-link mapping element, and the TID-to-link mapping element indicates a TID mapping rule.

With reference to the third aspect, in a possible implementation, the transceiver unit is further configured to send a data packet, where a TID of the data packet is set based on the QoS map element when the data packet does not match the SCS stream, or a TID of the data packet is set based on the TID-to-link mapping element carried in the SCS response frame when the data packet matches the SCS stream.

According to a fourth aspect, the present disclosure provides a communication apparatus. The communication apparatus may be a non-AP MLD or a chip in a non-AP MLD, for example, a Wi-Fi chip. The communication apparatus includes: a transceiver unit configured to receive a first frame on a first link; and a processing unit configured to parse the first frame, where the first frame includes a supported rates and BSS membership selectors element, the supported rates and BSS membership selectors element includes first indication information, and the first indication information indicates that the non-AP MLD is disallowed to initiate multi-link setup with an AP MLD on the first link. The first link is a link on which only a low-latency service is allowed to be transmitted or a link to which only a TID corresponding to a low-latency service is allowed to be mapped, that is, the first link is a clean link.

With reference to the fourth aspect, in a possible implementation, the transceiver unit is further configured to receive a beacon frame or a probe response frame on a second link, where the beacon frame or the probe response frame includes an RNR element, the RNR element includes a neighbor AP information field corresponding to a first AP, a channel number field in the neighbor AP information field is set to 0, and the first AP is an AP operating on the first link in the AP MLD.

With reference to the fourth aspect, in a possible implementation, when the first frame is an association response frame or a reassociation response frame, the first frame further includes a QoS map element, where the QoS map element includes respective DSCP range fields corresponding to eight different user priorities; DSCP ranges indicated by DSCP range fields corresponding to m user priorities in the eight different user priorities (0 to 7) cover DSCP space; and DSCP low value fields and DSCP high value fields in DSCP range fields corresponding to remaining (8−m) user priorities in the eight different user priorities are all set to 255. m is a positive integer less than 8, and the DSCP space is an interval [0, 63].

With reference to the fourth aspect, in a possible implementation, the transceiver unit is further configured to: send an SCS request frame, where the SCS request frame includes an SCS identifier field, and the SCS identifier field indicates a reported SCS stream; and receive an SCS response frame, where the SCS response frame includes a status code field, and the status code field indicates whether the AP MLD accepts the SCS stream.

Optionally, when the status code field indicates that the AP MLD accepts the SCS stream, the SCS response frame further includes a TID-to-link mapping element, and the TID-to-link mapping element indicates a TID mapping rule.

With reference to the fourth aspect, in a possible implementation, the transceiver unit is further configured to send a data packet, where a TID of the data packet is set based on the QoS map element when the data packet does not match the SCS stream, or a TID of the data packet is set based on the TID-to-link mapping element carried in the SCS response frame when the data packet matches the SCS stream.

In a possible implementation of any one of the foregoing aspects, the first indication information may be that a BSS membership selector in the supported rates and BSS membership selectors element is set to a preset value, for example, 120, 121, or another unused value. In other words, when the BSS membership selector is set to the preset value, it indicates that the non-AP MLD can perform only restricted multi-link setup. To be specific, the non-AP MLD can initiate multi-link setup only through another link (a link other than the clean link) to set up the link (the clean link).

In a possible implementation of any one of the foregoing aspects, the first indication information further indicates that a single-link station supporting an extremely high throughput protocol is disallowed to set up association with the AP MLD on the first link. In this way, when the EHT STA on the single link can read the first indication information, transmission of the non-low-latency service on the clean link can be prevented.

In a possible implementation of any one of the foregoing aspects, the first frame is any one of the following: a beacon frame, a probe response frame, an association response frame, or a reassociation response frame. When the first frame is the beacon frame (even if the non-AP MLD sends a probe request frame and/or an association request frame on the first link), the AP MLD is disallowed to reply with a (corresponding) probe response frame and/or association response frame on the first link. When the first frame is the probe response frame, the AP MLD is disallowed to reply with an association response frame on the first link. When the first frame is any one of the beacon frame, the probe response frame, the association response frame, or the reassociation response frame, the AP MLD may reject this association (sent on the first link) by using the status code field in the association response frame or the reassociation response frame. In this way, a probability that a collision occurs when the low-latency service is transmitted on the first link can be reduced.

Beneficial effect of the first aspect to the fourth aspect may be mutually referred.

According to a fifth aspect, the present disclosure provides a multi-link communication method. The method is mainly used after multi-link setup or after an association process, and the method includes: An AP MLD sends a beacon frame on a first link, where the beacon frame includes a supported rates and BSS membership selectors element, the supported rates and BSS membership selectors element includes first indication information, and the first indication information indicates that a first non-AP MLD is disallowed to initiate multi-link setup with the AP MLD on the first link. Then, the AP MLD sends a BTM (BTM) request frame on the first link, where the BTM request frame includes second indication information, the second indication information indicates a second non-AP MLD associated with the AP MLD to ignore the BTM request frame, and the BTM request frame is used to request a first station associated with a first AP to perform BSS transition. The first AP may be an AP operating on the first link in the AP MLD. The first station supports only a protocol earlier than an extremely high throughput (or 802.11be) protocol, that is, the first station is a legacy station. The first non-AP MLD is a non-AP MLD that has not been associated.

In the present disclosure, the AP MLD has at least two links, and the at least two links include the first link and a second link. In the association process, the legacy STA is allowed to associate with a single-link EHT STA on both the first link and the second link of the AP MLD, and a non-AP MLD is also allowed to initiate multi-link setup on the first link and the second link. However, after association succeeds, the AP MLD wants to use, at a moment, the first link as a link on which only a low-latency service is allowed to be transmitted or a link to which only a TID corresponding to a low-latency service is allowed to be mapped.

In this solution, after the association succeeds, when the AP MLD wants to use a link as a clean link at a moment, the AP MLD sends the beacon frame carrying the supported rates and BSS membership selectors element on the link, where the element carries the indication information, and the indication information indicates that the non-AP MLD that has not been associated is disallowed to initiate multi-link setup with the AP MLD on the first link. In addition, the BTM request frame is further sent on this link, and the indication information carried in the BTM request frame indicates the associated non-AP MLD to ignore the frame, and the associated legacy STA performs BSS transition. In this way, the low-latency service on the link is not interfered by a non-low-latency service.

With reference to the fifth aspect, in a possible implementation, the method further includes: The AP MLD sends a beacon frame or a probe response frame on the second link, where the beacon frame or the probe response frame includes an RNR element, the RNR element includes a neighbor AP information field corresponding to the first AP, a channel number field in the neighbor AP information field is set to 0, and the first AP is an AP operating on the first link in the AP MLD.

According to a sixth aspect, the present disclosure provides a multi-link communication method. The method is mainly used after multi-link setup or after an association process, and the method includes: A first station receives a beacon frame on a first link, where the beacon frame includes a supported rates and BSS membership selectors element, the supported rates and BSS membership selectors element includes first indication information, and the first indication information indicates that a first non-AP MLD is disallowed to initiate multi-link setup with an AP MLD on the first link. Then, the first station receives a BTM request frame on the first link, where the BTM request frame includes second indication information, the second indication information indicates a second non-AP MLD associated with the AP MLD to ignore the BTM request frame, and the BTM request frame is used to request the first station associated with a first AP to perform BSS transition. The first AP may be an AP operating on the first link in the AP MLD. The first station supports only a protocol earlier than an extremely high throughput (or 802.11be) protocol, that is, the first station is a legacy station. The first non-AP MLD is a non-AP MLD that has not been associated.

According to a seventh aspect, the present disclosure provides a communication apparatus. The communication apparatus may be an AP MLD or a chip in an AP MLD, for example, a Wi-Fi chip. The communication apparatus includes: a transceiver unit configured to send a beacon frame on a first link, where the beacon frame includes a supported rates and BSS membership selectors element, the supported rates and BSS membership selectors element includes first indication information, and the first indication information indicates that a first non-AP MLD is disallowed to initiate multi-link setup with the AP MLD on the first link, where the transceiver unit is further configured to send a BTM request frame on the first link, where the BTM request frame includes second indication information, the second indication information indicates a second non-AP MLD associated with the AP MLD to ignore the BTM request frame, and the BTM request frame is used to request a first station associated with a first AP to perform BSS transition. The first AP may be an AP operating on the first link in the AP MLD. The first station supports only a protocol earlier than an extremely high throughput protocol, that is, the first station is a legacy station. The first non-AP MLD is a non-AP MLD that has not been associated.

Optionally, the communication apparatus further includes a processing unit configured to generate the beacon frame and the BTM request frame.

With reference to the seventh aspect, in a possible implementation, the transceiver unit is further configured to send a beacon frame or a probe response frame on a second link, where the beacon frame or the probe response frame includes an RNR element, the RNR element includes a neighbor AP information field corresponding to the first AP, a channel number field in the neighbor AP information field is set to 0, and the first AP is an AP operating on the first link in the AP MLD.

According to an eighth aspect, the present disclosure provides a communication apparatus. The communication apparatus may be a first station or a chip in a first station, for example, a Wi-Fi chip. The communication apparatus includes: a transceiver unit configured to receive a beacon frame on a first link, where the beacon frame includes a supported rates and BSS membership selectors element, the supported rates and BSS membership selectors element includes first indication information, and the first indication information indicates that a first non-AP MLD is disallowed to initiate multi-link setup with an AP MLD on the first link, where the transceiver unit is further configured to receive a BTM request frame on the first link, where the BTM request frame includes second indication information, the second indication information indicates a second non-AP MLD associated with the AP MLD to ignore the BTM request frame, and the BTM request frame is used to request the communication apparatus associated with a first AP to perform BSS transition. The first AP may be an AP operating on the first link in the AP MLD. The communication apparatus supports only a protocol earlier than an extremely high throughput (or 802.11be) protocol, that is, the communication apparatus is a legacy station. The first non-AP MLD is a non-AP MLD that has not been associated.

Optionally, the communication apparatus further includes a processing unit configured to parse the beacon frame and the BTM request frame.

In a possible implementation of any one of the fifth to eighth aspects, the first indication information may be that a BSS membership selector in the supported rates and BSS membership selectors element is set to a preset value, for example, 120, 121, or another unused value. In other words, when the BSS membership selector is set to the preset value, it indicates that the non-AP MLD can perform only restricted multi-link setup. To be specific, the non-AP MLD can initiate multi-link setup only through another link (a link other than the clean link) to set up the link (the clean link).

In a possible implementation of any one of the fifth to eighth aspects, the first indication information further indicates that a single-link station supporting an extremely high throughput protocol is disallowed to set up association with the AP MLD on the first link.

In a possible implementation of any one of the fifth to eighth aspects, the AP MLD is disallowed to reply with a (corresponding) probe response frame and/or association response frame on the first link.

Beneficial effect of the fifth aspect to the eighth aspect may be mutually referred.

According to a ninth aspect, the present disclosure provides a multi-link communication method. The method is mainly used in an enhanced link subset mapping scenario, and the method includes: A first device generates and sends an association response frame or a reassociation response frame, where the association response frame or the reassociation response frame includes a QoS map element. The QoS map element includes respective DSCP range fields corresponding to eight different user priorities; DSCP ranges indicated by DSCP range fields corresponding to m user priorities in the eight different user priorities cover DSCP space; and DSCP low value fields and DSCP high value fields in DSCP range fields corresponding to remaining (8−m) user priorities in the eight different user priorities are all set to 255.

In other words, DSCP ranges indicated by DSCP range fields corresponding to all TIDs in a first TID set in the QoS map element cover the entire DSCP space, namely, an interval [0, 63]; and DSCP low value fields and DSCP high value fields in DSCP range fields corresponding to all TIDs in a second TID set are all set to 255. The first TID set includes one or more TIDs, and the second TID set includes one or more TIDs. A union set of the first TID set and the second TID set is TID space, in other words, 0, 1, 2, 3, 4, 5, 6, and 7. The TIDs in the first TID set are used to identify non-low-latency services, and the TIDs in the second TID set are used to identify low-latency services, or only an AP MLD is allowed to map an SCS stream successfully added according to an SCS mechanism to the second TID set.

The first device is an AP or an AP MLD, the DSCP space is the interval [0, 63], and m is a positive integer less than 8.

The user priority and the TID are not distinguished in the present disclosure. There is a one-to-one correspondence between the user priority and the TID, and the user priority and the TID may be used alternatively in the present disclosure.

In this solution, the TID space (0 to 7) is divided into two parts by using the QoS map element. One part is used for non-low-latency services, and the other part is used for low-latency services. Whether a corresponding MPDU is low-latency service data or non-low-latency service data may be distinguished by using a TID, in other words, a low-latency service and a non-low-latency service are not mapped to a same TID. In addition, this solution may further support implementation of an enhanced link subset mapping scheme, so that a clean link can be used to transmit only a low-latency service.

According to a tenth aspect, the present disclosure provides a multi-link communication method. The method is mainly used in an enhanced link subset mapping scenario, and the method includes: A second device receives and parses an association response frame or a reassociation response frame, where the association response frame or the reassociation response frame includes a QoS map element. The QoS map element includes respective DSCP range fields corresponding to eight different user priorities; DSCP ranges indicated by DSCP range fields corresponding to m user priorities in the eight different user priorities cover DSCP space; and DSCP low value fields and DSCP high value fields in DSCP range fields corresponding to remaining (8−m) user priorities in the eight different user priorities are all set to 255.

The second device is an EHT STA or a non-AP MLD, the DSCP space is an interval [0, 63], and m is a positive integer less than 8.

According to an eleventh aspect, the present disclosure provides a communication apparatus. The communication apparatus may be a first device or a chip in a first device, for example, a Wi-Fi chip. The communication apparatus includes a processing unit configured to generate an association response frame or a reassociation response frame, where the association response frame or the reassociation response frame includes a QoS map element; the QoS map element includes respective DSCP range fields corresponding to eight different user priorities; DSCP ranges indicated by DSCP range fields corresponding to m user priorities in the eight different user priorities cover DSCP space, where the DSCP space is an interval [0, 63]; and DSCP low value fields and DSCP high value fields in DSCP range fields corresponding to remaining (8-m) user priorities in the eight different user priorities are all set to 255; and a transceiver unit configured to send the association response frame or the reassociation response frame, where m is a positive integer less than 8.

According to a twelfth aspect, the present disclosure provides a communication apparatus. The communication apparatus may be a second device or a chip in a second device, for example, a Wi-Fi chip. The communication apparatus includes: a transceiver unit configured to receive an association response frame or a reassociation response frame; and a processing unit configured to parse the association response frame or the reassociation response frame, where the association response frame or the reassociation response frame includes a QoS map element; the QoS map element includes respective DSCP range fields corresponding to eight different user priorities; DSCP ranges indicated by DSCP range fields corresponding to m user priorities in the eight different user priorities cover DSCP space, where the DSCP space is an interval [0, 63]; and DSCP low value fields and DSCP high value fields in DSCP range fields corresponding to remaining (8−m) user priorities in the eight different user priorities are all set to 255. m is a positive integer less than 8.

For beneficial effect of the tenth aspect, the eleventh aspect, and the twelfth aspect, refer to the effective effect described in the ninth aspect.

According to a thirteenth aspect, the present disclosure provides a multi-link communication method. The method includes: An AP MLD receives an SCS request frame, where the SCS request frame carries a TID-to-link mapping element, and the TID-to-link mapping element indicates a TID mapping rule. The AP MLD sends an SCS response frame.

In this solution, TID-to-link mapping negotiation is performed during SCS negotiation. This can reduce signaling overheads and improve accuracy.

According to a fourteenth aspect, the present disclosure provides a multi-link communication method. The method includes: A non-AP MLD sends an SCS request frame, where the SCS request frame carries a TID-to-link mapping element, and the TID-to-link mapping element indicates a TID mapping rule. The non-AP MLD receives an SCS response frame.

According to a fifteenth aspect, the present disclosure provides a communication apparatus. The communication apparatus may be an AP MLD or a chip in an AP MLD, for example, a Wi-Fi chip. The communication apparatus includes: a transceiver unit configured to receive an SCS request frame, where the SCS request frame carries a TID-to-link mapping element, and the TID-to-link mapping element indicates a TID mapping rule, where the transceiver unit is further configured to send an SCS response frame.

Optionally, the communication apparatus further includes a processing unit configured to generate the SCS response frame.

According to a sixteenth aspect, the present disclosure provides a communication apparatus. The communication apparatus may be a non-AP MLD or a chip in a non-AP MLD, for example, a Wi-Fi chip. The communication apparatus includes a transceiver unit configured to send an SCS request frame, where the SCS request frame carries a TID-to-link mapping element, and the TID-to-link mapping element indicates a TID mapping rule, where the transceiver unit is further configured to receive an SCS response frame.

Optionally, the communication apparatus further includes a processing unit configured to generate the SCS request frame.

In a possible implementation of any one of the thirteenth to sixteenth aspects, the SCS request frame includes an SCS identifier (SCSID) field, where the SCS identifier field indicates a reported SCS stream. The SCS response frame includes a status code field, and the status code field indicates whether the AP MLD accepts the SCS stream reported by using the SCS request frame. When the status code field indicates that the AP MLD accepts the SCS stream, the SCS response frame further carries the TID-to-link mapping element indicating a TID mapping rule. When the status code field indicates that the AP MLD rejects the SCS stream, the SCS response frame does not carry the TID-to-link mapping element.

In this solution, whether the SCS response frame carries the TID-to-link mapping element indicates whether the AP MLD accepts TID-to-link mapping negotiation. The implementation is simple.

Beneficial effect of the thirteenth aspect to the sixteenth aspect may be mutually referred.

According to a seventeenth aspect, the present disclosure provides a multi-link communication method. The method includes: An AP MLD receives an SCS request frame, where the SCS request frame includes an SCS identifier field, and the SCS identifier field indicates a reported SCS stream. The AP MLD sends an SCS response frame, where the SCS response frame includes a status code field, and the status code field is set to a first value (for example, 0) to indicate that the AP MLD accepts the SCS stream. The SCS response frame further carries a TID-to-link mapping element, and the TID-to-link mapping element indicates a TID mapping rule. The SCS response frame indicates a non-AP MLD to transmit data according to the TID mapping rule indicated by the TID-to-link mapping element.

In this solution, the TID-to-link mapping element is directly carried in the SCS response frame to indicate the non-AP MLD to transmit the data according to the TID mapping rule indicated by the TID-to-link mapping element. This can reduce signaling overheads.

According to an eighteenth aspect, the present disclosure provides a multi-link communication method. The method includes: A non-AP MLD sends an SCS request frame, where the SCS request frame includes an SCS identifier field, and the SCS identifier field indicates a reported SCS stream. The non-AP MLD receives an SCS response frame, where the SCS response frame includes a status code field, and the status code field is set to a first value (for example, 0), to indicate that an AP MLD accepts the SCS stream. The SCS response frame further carries a TID-to-link mapping element, and the TID-to-link mapping element indicates a TID mapping rule. The SCS response frame indicates the non-AP MLD to transmit data according to the TID mapping rule indicated by the TID-to-link mapping element.

According to a nineteenth aspect, the present disclosure provides a communication apparatus. The communication apparatus may be an AP MLD or a chip in an AP MLD, for example, a Wi-Fi chip. The communication apparatus includes: a transceiver unit configured to receive an SCS request frame, where the SCS request frame includes an SCS identifier field, and the SCS identifier field indicates a reported SCS stream, where the transceiver unit is further configured to send an SCS response frame, where the SCS response frame includes a status code field, and the status code field is set to a first value (for example, 0), to indicate that the AP MLD accepts the SCS stream. The SCS response frame further carries a TID-to-link mapping element, and the TID-to-link mapping element indicates a TID mapping rule. The SCS response frame indicates a non-AP MLD to transmit data according to the TID mapping rule indicated by the TID-to-link mapping element.

Optionally, the communication apparatus further includes a processing unit configured to generate the SCS response frame.

According to a twentieth aspect, the present disclosure provides a communication apparatus. The communication apparatus may be a non-AP MLD or a chip in a non-AP MLD, for example, a Wi-Fi chip. The communication apparatus includes: a transceiver unit configured to send an SCS request frame, where the SCS request frame includes an SCS identifier field, and the SCS identifier field indicates a reported SCS stream, where the transceiver unit is further configured to receive an SCS response frame, where the SCS response frame includes a status code field, and the status code field is set to a first value (for example, 0), to indicate that an AP MLD accepts the SCS stream. The SCS response frame further carries a TID-to-link mapping element, and the TID-to-link mapping element indicates a TID mapping rule. The SCS response frame indicates the non-AP MLD to transmit data according to the TID mapping rule indicated by the TID-to-link mapping element.

Optionally, the communication apparatus further includes a processing unit configured to generate the SCS request frame.

Beneficial effect of the seventeenth aspect to the twentieth aspect may be mutually referred.

According to a twenty-first aspect, the present disclosure provides a multi-link communication method. The method includes: An AP MLD receives an SCS request frame, where the SCS request frame includes an SCS identifier field and a QOS characteristic element, the SCS identifier field indicates a reported SCS stream, the QoS characteristic element includes third indication information, and the third indication information indicates an access mode of the SCS stream. The AP MLD sends an SCS response frame.

In this solution, the indication information is carried in the QoS characteristic element to indicate the access mode requested by a STA, and an access policy of a corresponding traffic stream may be indicated according to an SCS mechanism. This reduces signaling overheads.

According to a twenty-second aspect, the present disclosure provides a multi-link communication method. The method includes: A non-AP MLD sends an SCS request frame, where the SCS request frame includes an SCS identifier field and a QoS characteristic element, the SCS identifier field indicates a reported SCS stream, the QoS characteristic element includes third indication information, and the third indication information indicates an access mode of the SCS stream. The non-AP MLD receives an SCS response frame.

According to a twenty-third aspect, the present disclosure provides a communication apparatus. The communication apparatus may be an AP MLD or a chip in an AP MLD, for example, a Wi-Fi chip. The communication apparatus includes a transceiver unit configured to receive an SCS request frame, where the SCS request frame includes an SCS identifier field and a QoS characteristic element, the SCS identifier field indicates a reported SCS stream, the QoS characteristic element includes third indication information, and the third indication information indicates an access mode of the SCS stream. The transceiver unit is further configured to send an SCS response frame.

Optionally, the communication apparatus further includes a processing unit configured to generate the SCS response frame.

According to a twenty-fourth aspect, the present disclosure provides a communication apparatus. The communication apparatus may be a non-AP MLD or a chip in a non-AP MLD, for example, a Wi-Fi chip. The communication apparatus includes a transceiver unit configured to send an SCS request frame, where the SCS request frame includes an SCS identifier field and a QoS characteristic element, the SCS identifier field indicates a reported SCS stream, the QoS characteristic element includes third indication information, and the third indication information indicates an access mode of the SCS stream. The transceiver unit is further configured to receive an SCS response frame.

Optionally, the communication apparatus further includes a processing unit configured to generate the SCS request frame.

In a possible implementation of any one of the twenty-first to twenty-fourth aspects, the QoS characteristic element may further include fourth indication information, and the fourth indication information indicates an access category to which a data packet of the SCS stream is mapped.

Optionally, both the third indication information and the fourth indication information may be located in a control information field of the QoS characteristic element.

In this solution, the QoS characteristic element further indicates the access category to which the data packet of the SCS stream is mapped, so that an access policy and an access category of a traffic stream are negotiated by using one procedure. This reduces signaling overheads.

Beneficial effect of the twenty-first aspect to the twenty-fourth aspect may be mutually referred.

According to a twenty-fifth aspect, the present disclosure provides a communication apparatus, where the communication apparatus includes a processor and a transceiver. The transceiver is configured to receive and receive various frames, and a computer program includes program instructions. When the processor runs the program instructions, the communication apparatus is enabled to perform the multi-link communication method described in any one of the possible implementations of any one of the first aspect, the second aspect, the fifth aspect, the sixth aspect, the ninth aspect, the tenth aspect, the thirteenth aspect, the fourteenth aspect, the seventeenth aspect, the eighteenth aspect, the twenty-first aspect, or the twenty-second aspect. The transceiver may be a radio frequency module, a combination of a radio frequency module and an antenna, or an input/output interface of a chip or a circuit in the communication apparatus. Optionally, the communication apparatus further includes a memory, and the memory is configured to store the computer program.

According to a twenty-sixth aspect, the present disclosure provides a computer-readable storage medium, where the computer-readable storage medium stores program instructions. When the program instructions are run on a computer, the computer is enabled to perform the multi-link communication method described in any one of the possible implementations of any one of the first aspect, the second aspect, the fifth aspect, the sixth aspect, the ninth aspect, the tenth aspect, the thirteenth aspect, the fourteenth aspect, the seventeenth aspect, the eighteenth aspect, the twenty-first aspect, or the twenty-second aspect.

According to a twenty-seventh aspect, the present disclosure provides a program product including program instructions. When the program product runs, the multi-link communication method described in any one of the possible implementations of any one of the first aspect, the second aspect, the fifth aspect, the sixth aspect, the ninth aspect, the tenth aspect, the thirteenth aspect, the fourteenth aspect, the seventeenth aspect, the eighteenth aspect, the twenty-first aspect, or the twenty-second aspect is performed.

According to a twenty-eighth aspect, the present disclosure provides an apparatus. The apparatus may be implemented in a form of a chip, or may be in a form of a device. The apparatus includes a processing circuit and an input/output interface. The input/output interface is configured to transmit/receive a frame. The processing circuit is configured to read and execute a program stored in a memory, to perform the multi-link communication method described in any one of the possible implementations of any one of the first aspect, the second aspect, the fifth aspect, the sixth aspect, the ninth aspect, the tenth aspect, the thirteenth aspect, the fourteenth aspect, the seventeenth aspect, the eighteenth aspect, the twenty-first aspect, or the twenty-second aspect. Optionally, the apparatus further includes the memory, and the memory is connected to a processor through a circuit.

Optionally, the processor and the memory may be physically mutually independent units, or the memory may be integrated with the processor.

Embodiments of the present disclosure are implemented, to prevent the low-latency service on the link (namely, the clean link) to which only the TID corresponding to the low-latency service is allowed to be mapped from being interfered by the non-low-latency service.

### BRIEF DESCRIPTION OF DRAWINGS

To describe technical solutions in embodiments of the present disclosure more clearly, the following briefly describes accompanying drawings used for describing embodiments.

FIG. 1 is a schematic diagram of an architecture of a wireless communication system according to an embodiment of the present disclosure;

FIG. 2 is a schematic diagram of multi-link communication according to an embodiment of the present disclosure;

FIG. 3A is a schematic diagram of a structure of a multi-link device according to an embodiment of the present disclosure;

FIG. 3B is a schematic diagram of another structure of a multi-link device according to an embodiment of the present disclosure;

FIG. 4 is a schematic diagram of a connection between an AP MLD and a non-AP MLD according to an embodiment of the present disclosure;

FIG. 5 is a schematic diagram of a frame format of a multi-link element according to an embodiment of the present disclosure;

FIG. 6 is a schematic diagram of a frame format of an SCS request frame according to an embodiment of the present disclosure;

FIG. 7A is a schematic diagram of a frame format of an SCS descriptor element according to an embodiment of the present disclosure;

FIG. 7B is a schematic diagram of another frame format of an SCS descriptor element according to an embodiment of the present disclosure;

FIG. 8 is a schematic diagram of a frame format of an intra-access category priority element according to an embodiment of the present disclosure;

FIG. 9 is a schematic diagram of a frame format of an SCS response frame according to an embodiment of the present disclosure;

FIG. 10 is a schematic diagram of a frame format of a TID-to-link mapping element according to an embodiment of the present disclosure;

FIG. 11 is a schematic diagram of a frame format of a QoS map element according to an embodiment of the present disclosure;

FIG. 12 is a schematic diagram of a frame format of an RNR element according to an embodiment of the present disclosure;

FIG. 13 is a schematic diagram of a BTM operation procedure according to an embodiment of the present disclosure;

FIG. 14 is a schematic diagram of transmission opportunity (TXOP) sharing according to an embodiment of the present disclosure;

FIG. 15 is a first schematic flowchart of a multi-link communication method according to an embodiment of the present disclosure;

FIG. 16 is a schematic diagram of a frame format of a supported rates and BSS membership selectors element according to an embodiment of the present disclosure;

FIG. 17A is a schematic diagram of a clean link in an AP MLD according to an embodiment of the present disclosure;

FIG. 17B is another schematic diagram of clean links in an AP MLD according to an embodiment of the present disclosure;

FIG. 18 is a second schematic flowchart of a multi-link communication method according to an embodiment of the present disclosure;

FIG. 19A is a schematic diagram of a frame format of a BTM request frame according to an embodiment of the present disclosure;

FIG. 19B is a schematic diagram of a frame format of a BTM response frame according to an embodiment of the present disclosure;

FIG. 20 is a third schematic flowchart of a multi-link communication method according to an embodiment of the present disclosure;

FIG. 21 is a fourth schematic flowchart of a multi-link communication method according to an embodiment of the present disclosure;

FIG. 22 is a fifth schematic flowchart of a multi-link communication method according to an embodiment of the present disclosure;

FIG. 23 is a schematic diagram of a frame format of a QoS characteristic element according to an embodiment of the present disclosure;

FIG. 24 is a schematic diagram of a frame format of a control information field according to an embodiment of the present disclosure;

FIG. 25 is a schematic diagram of a structure of a communication apparatus according to an embodiment of the present disclosure;

FIG. 26 is a schematic diagram of a structure of a communication apparatus according to an embodiment of the present disclosure; and

FIG. 27 is a schematic diagram of a structure of a communication apparatus according to an embodiment of the present disclosure.

### DESCRIPTION OF EMBODIMENTS

The following clearly and completely describes technical solutions in embodiments of the present disclosure with reference to accompanying drawings in embodiments of the present disclosure.

In descriptions of the present disclosure, unless otherwise specified, “/” means “or”. For example, A/B may indicate A or B. A term “and/or” in this specification describes only an association relationship between associated objects and indicates that there may be three relationships. For example, A and/or B may indicate the following three cases: Only A exists, both A and B exist, and only B exists. In addition, “at least one” means one or more, and “a plurality of” means two or more. “At least one of the following items (pieces)” or a similar expression thereof indicates any combination of these items, including a single item (piece) or any combination of a plurality of items (pieces). For example, at least one of a, b, or c may indicate a, b, c, a and b, a and c, b and c, or a, b, and c. a, b, and c each may be singular or plural.

In descriptions of the present disclosure, terms such as “first” and “second” do not limit a quantity and an execution sequence, and the terms such as “first” and “second” do not indicate a definite difference.

In the present disclosure, the term “example” or “for example” is used to represent giving an example, an illustration, or a description. Any embodiment or design scheme described as “example”, “such as” or “for example” in the present disclosure should not be explained as being more preferred or having more advantages than another embodiment or design scheme. Exactly, use of the term “example”, “such as”, “for example”, or the like is intended to present a concept in a specific manner.

In the present disclosure, an element indicated in a singular form is intended to indicate “one or more”, but does not indicate “one and only one”, unless otherwise specified.

It should be understood that in embodiments of the present disclosure, “B corresponding to A” indicates that B is associated with A, and B may be determined based on A. However, it should be further understood that determining B based on A does not mean that B is determined based only on A. B may alternatively be determined based on A and/or other information.

For ease of understanding methods provided in embodiments of the present disclosure, the following describes a system architecture of the methods provided in embodiments of the present disclosure. It may be understood that the system architecture described in embodiments of the present disclosure is intended to describe the technical solutions in embodiments of the present disclosure more clearly, and does not constitute any limitation on the technical solutions provided in embodiments of the present disclosure.

In the present disclosure, a next-generation 802.11 standard station device simultaneously supporting communication on a plurality of links is referred to as a multi-link device (MLD), and an internal entity responsible for any link is referred to as a station (STA). If all stations in an MLD are APs, the MLD may be further referred to as an AP MLD. If all stations in an MLD are non-access point stations (non-AP STAs), the MLD may be further referred to as a non-AP MLD. In other words, the multi-link device includes one or more affiliated stations (affiliated STAs). The affiliated station is a logical station and may operate on a link, a frequency band, or a channel. The affiliated station may be an AP (AP) or a non-access point station (non-AP STA). In 802.11be, a multi-link device whose affiliated station is an AP is referred to as an AP multi-link device (AP MLD), and a multi-link device whose affiliated station is a non-AP STA is referred to as a non-AP multi-link device (non-AP MLD).

Optionally, one multi-link device may include a plurality of logical stations, each logical station operates on one link, but the plurality of logical stations are allowed to operate on a same link. During data transmission between an AP MLD and a non-AP MLD, a link identifier may be used to identify a link or a station on a link. Before communication, the AP MLD and the non-AP MLD may first negotiate or communicate for a correspondence between the link identifier and the link or the station on the link. Therefore, during data transmission, the link identifier is carried without transmitting a large amount of signaling information to indicate the link or the station on the link. This reduces signaling overheads and improves transmission efficiency.

Optionally, the multi-link device may comply with the 802.11 series protocols to implement wireless communication. For example, a station complying with an extremely high throughput (EHT) or a station complying with 802.11be or compatibly supporting 802.11be implements communication with another device. Certainly, the another device may be a multi-link device, or may not be a multi-link device.

The technical solutions provided in the present disclosure are mainly used in a WLAN, for example, in a scenario in which an AP MLD communicates with a non-AP MLD. Optionally, the communication scenario may alternatively include a legacy STA supporting transmission on only a single link. In embodiments of the present disclosure, the term “communication” may also be described as “data transmission”, “information transmission”, or “transmission”. The term “transmission” may generally refer to sending and receiving.

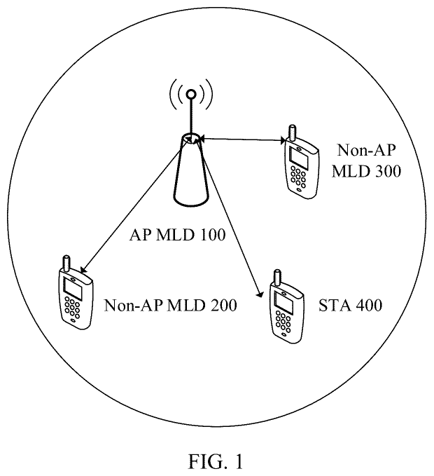

FIG. 1 is a schematic diagram of an architecture of a wireless communication system according to an embodiment of the present disclosure. As shown in FIG. 1, the wireless communication system includes at least one AP MLD (for example, an AP MLD 100 in FIG. 1) and at least one non-AP MLD (for example, a non-AP MLD 200 and a non-AP MLD 300 in FIG. 1). Optionally, FIG. 1 further includes a legacy station (for example, a single-link non-AP STA 400 in FIG. 1, also referred to as a STA 400) supporting transmission only on a single link. The AP MLD is a device that provides a service for the non-AP MLD, and the non-AP MLD may communicate with the AP MLD through a plurality of links, to increase a throughput. A STA in the non-AP MLD may alternatively communicate with an AP in the AP MLD through a link. It may be understood that a quantity of AP MLDs and a quantity of non-AP MLDs in FIG. 1 are merely examples.

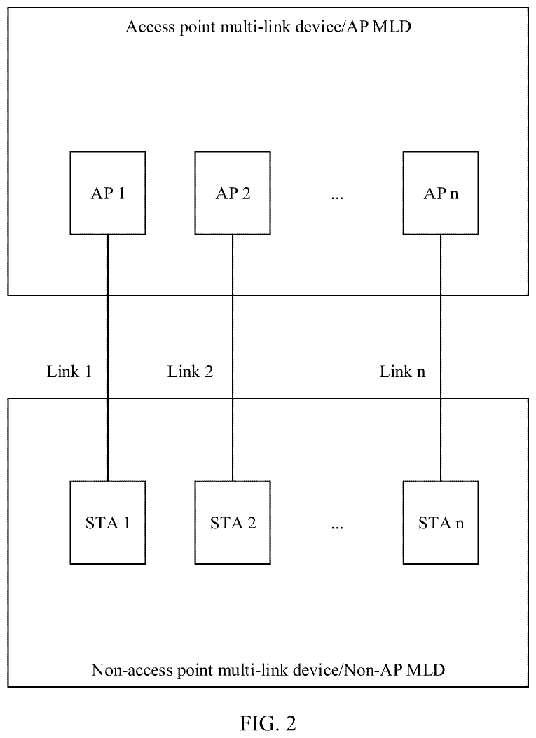

Optionally, refer to FIG. 2. FIG. 2 is a schematic diagram of multi-link communication according to an embodiment of the present disclosure. As shown in FIG. 2, an AP MLD includes n stations, which are an AP 1, an AP 2, . . . , and an AP n. A non-AP MLD also includes n stations, which are a STA 1, a STA 2, . . . , and a STA n. Communication between the MLDs is multi-link communication, and a link 1 to a link n in FIG. 2 form multi-link communication. In other words, the AP MLD and the non-AP MLD may perform parallel communication on the link 1, the link 2, . . . , and the link n. An AP in the AP MLD may set up an association relationship with a STA in the non-AP MLD. For example, the STA 1 in the non-AP MLD sets up an association relationship with the AP 1 in the AP MLD. The STA 2 in the non-AP MLD sets up an association relationship with the AP 2 in the AP MLD. The STA n in the non-AP MLD sets up an association relationship with the AP n in the AP MLD.

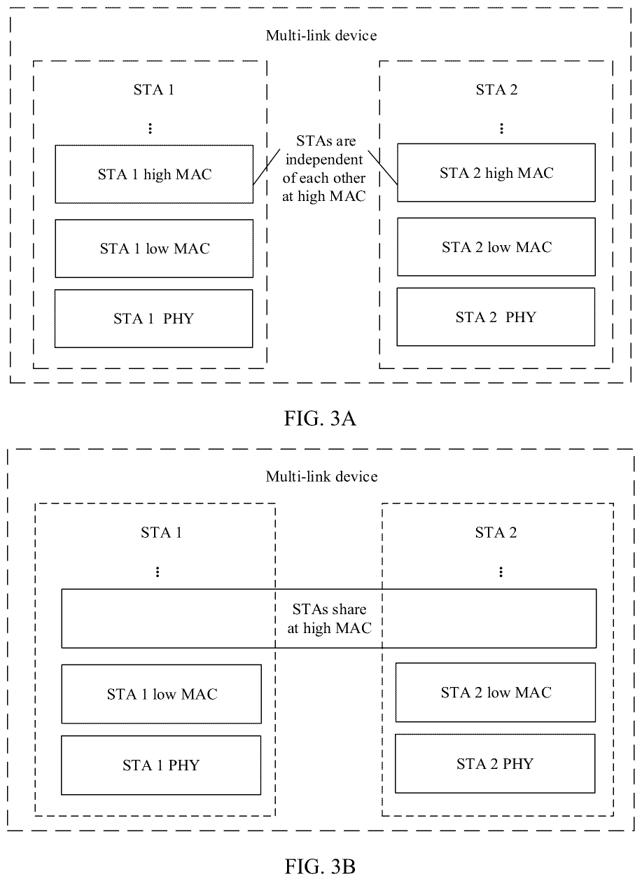

Optionally, refer to FIG. 3A. FIG. 3A is a schematic diagram of a structure of a multi-link device according to an embodiment of the present disclosure. The 802.11 standard focuses on an 802.11 physical layer (PHY) part and a MAC layer part in a multi-link device. As shown in FIG. 3A, a plurality of STAs included in the multi-link device are independent of each other at a low MAC layer and a PHY layer, and are also independent of each other at a high MAC layer. FIG. 3B is a schematic diagram of another structure of a multi-link device according to an embodiment of the present disclosure. As shown in FIG. 3B, a plurality of STAs included in the multi-link device are independent of each other at a low MAC layer and a PHY layer, and share a high MAC layer. Certainly, in a multi-link communication process, a non-AP MLD may use a structure with independent high MAC layers, and an AP MLD uses a structure with a shared high MAC layer; or a non-AP MLD may use a structure with a shared high MAC layer, and an AP MLD uses a structure with independent high MAC layers; or each of a non-AP MLD and an AP MLD may use a structure with a shared high MAC layer; or each of a non-AP MLD and an AP MLD may use a structure with independent high MAC layers. A schematic diagram of an internal structure of the multi-link device is not limited in embodiments of the present disclosure. FIG. 3A and FIG. 3B are merely examples for description. For example, the high MAC layer or the low MAC layer may be implemented by one processor in a chip system of the multi-link device, or may be implemented by different processing modules in a chip system.

Optionally, operations such as allocation of a sequence number (SN) and a packet number (PN) of a MAC service data unit (MSDU), encryption, and decryption are mainly completed at the high-MAC. Operations such as assembling of a MPDU) of a respective link, channel access, packet sending, and reception confirmation are mainly completed at the low-MAC.

In embodiments of the present disclosure, the multi-link device may allow services of a same traffic identifier (TID) to be transmitted on different links, and even allow a same data packet to be transmitted on different links; and alternatively, may not allow services of a same TID to be transmitted on different links, but allow services of different TIDs to be transmitted on different links.

A frequency band in which the multi-link device operates may include one or more frequency bands of sub 1 gigahertz (GHz), 2.4 GHz, 5 GHZ, 6 GHZ, and high-frequency 60 GHz.

For example, the multi-link device in embodiments of the present disclosure may be a single-antenna device, or may be a multi-antenna device. For example, the multi-link device may be a device with more than two antennas. A quantity of antennas included in the multi-link device is not limited in embodiments of the present disclosure.

For example, the multi-link device (which may be a non-AP MLD or an AP MLD herein) is an apparatus with a wireless communication function. The apparatus may be an integrated device, or may be a chip, a processing system, or the like installed in the integrated device. A device on which the chip or processing system is installed may implement, under control of the chip or processing system, the methods and functions provided in embodiments of the present disclosure. For example, the non-AP MLD in embodiments of the present disclosure has a wireless transceiver function, may support the 802.11 series protocols, and may communicate with an AP MLD, a single-link device, or another non-AP MLD. For example, the non-AP MLD is any user communication device that allows a user to communicate with an AP and communicate with a WLAN. For example, the non-AP MLD may be user equipment that can connect to a network, for example, a tablet computer, a desktop computer, a laptop computer, a notebook computer, an ultra-mobile personal computer (UMPC), a handheld computer, a netbook, a personal digital assistant (PDA), or a mobile phone. The non-AP MLD may be an internet of things node in the internet of things, a vehicle-mounted communication apparatus in the internet of vehicles, or the like. The non-AP MLD may alternatively be a chip and a processing system in each of the foregoing terminals. The AP MLD may be an apparatus that provides services for the non-AP MLD, and may support the 802.11 series protocols. For example, the AP MLD may be a communication entity such as a communication server, a router, a switch, or a bridge, or the AP MLD may include a macro base station, a micro base station, a relay station, and the like in various forms. Certainly, the AP MLD may alternatively be a chip and a processing system in each of the devices in various forms. In this way, the methods and the functions in embodiments of the present disclosure are implemented. The 802.11 protocol may be a protocol that supports 802.11be or is compatible with 802.11be.

It may be understood that the multi-link device may support high-rate and low-latency transmission. With continuous evolution of application scenarios of the wireless local area network, the multi-link device may be further used in more scenarios, for example, a sensor node (for example, a smart meter, a smart electricity meter, or a smart air detection node) in a smart city, a smart device (for example, a smart camera, a projector, a display, a TV, a stereo, a refrigerator, or a washing machine) in a smart home, a node in the internet of things, an entertainment terminal (for example, a wearable device such as augmented reality (AR) or virtual reality (VR)), a smart device (for example, a printer or a projector) in a smart office, an internet of vehicles device in the internet of vehicles, and some infrastructures (for example, a vending machine, a self-service navigation station of a supermarket, a self-service cash register device, and a self-service ordering machine) in daily life scenarios. Specific forms of the non-AP MLD and the AP MLD are not limited in embodiments of the present disclosure, and are merely examples for description herein.

The foregoing content briefly describes a system structure in embodiments of the present disclosure, and the following briefly describes related content, terms, or nouns in the present disclosure.

### 1. Multi-Link Setup

A non-AP MLD may simultaneously set up association with a plurality of links of an AP MLD by performing a multi-link setup operation on one link. A link on which an association request/response frame is exchanged is referred to as a transmitted link, and correspondingly, another link is referred to as a non-transmitted link. The association request/response frame carries information about the plurality of links by using a multi-link element, to implement simultaneous association with the plurality of links.

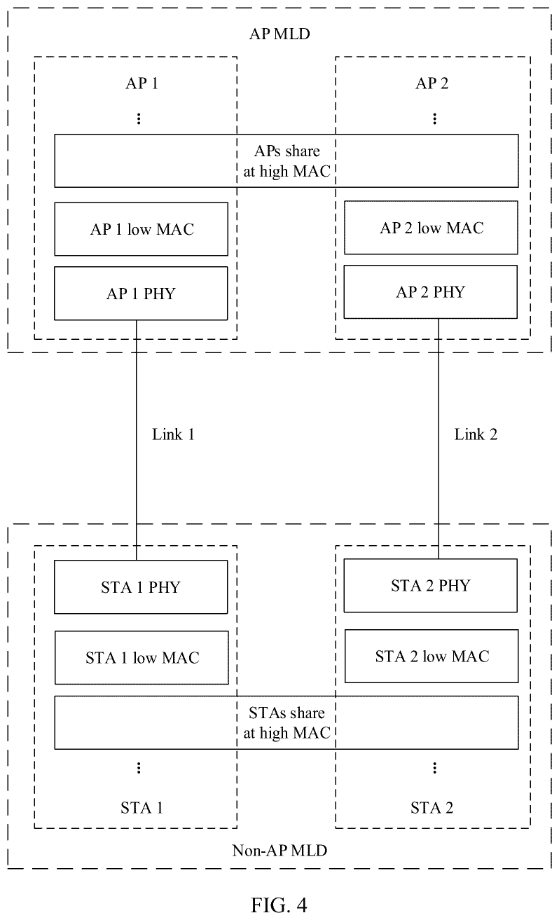

FIG. 4 is a schematic diagram of a connection between an AP MLD and a non-AP MLD according to an embodiment of the present disclosure. As shown in FIG. 4, each of the non-AP MLD and the AP MLD uses a structure with a shared high MAC layer. It is assumed that the AP MLD includes two APs, and the non-AP MLD includes two STAs. With reference to FIG. 4, a multi-link setup procedure is as follows: The non-AP MLD sends, on a link 1, an association request frame carrying a multi-link element. The link 1 is a transmitted link, and a link 2 is a non-transmitted link. After receiving the association request frame, the AP MLD relies with an association response frame carrying a multi-link element to the non-AP MLD on the link 1. The AP MLD may indicate, in the association response frame, whether each link requested to be set up is successfully set up or not. Association between the non-AP MLD and the AP MLD succeeds only when the transmitted link is accepted. For example, as shown in FIG. 4, when the transmitted link 1 is accepted, the non-AP MLD is successfully associated with the AP MLD, and the link 2 is successfully set up. To be specific, an AP 1 is connected to a STA 1 through the link 1, and an AP 2 is connected to a STA 2 through the link 2.

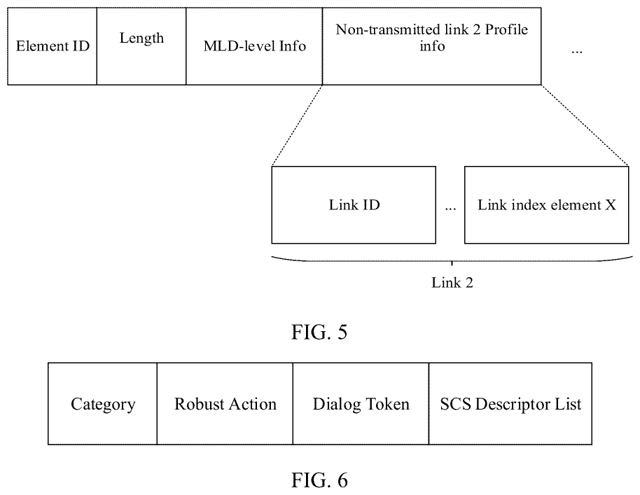

To reduce signaling overheads, an inherited model format is used for the multi-link element to carry MLD related information. FIG. 5 is a schematic diagram of a frame format of the multi-link element according to an embodiment of the present disclosure. As shown in FIG. 5, information carried in the multi-link element may be divided into two parts. One part is an MLD-level information field, and the other part is per link profile information, where each link herein is each non-transmitted link, for example, a non-transmitted link 2 profile information field in FIG. 5. When content of an element on a STA side (or an AP side) corresponding to a non-transmitted link is different from content of a same element on a STA side (or an AP side) corresponding to a transmitted link, information about the non-transmitted link is carried in per link profile info (per link configuration information).

The MLD-level info field in the multi-link element carries related information of a multi-link device, for example, service AP (SAP) MAC addresses of the non-AP MLD and the AP MLD. The per link configuration information starts with a link identifier (link ID), to indicate that this link configuration information is related information about a specific link. The non-AP MLD may obtain, by receiving a probe response frame or a beacon frame, link ID information corresponding to each link, an operating channel of each link, and a basic service set identifier (BSSID) corresponding to each link.

### 2. Stream Classification Service (SCS) Mechanism

A station (STA) side may report a low-latency traffic stream to an AP according to the SCS mechanism. Specifically, the STA may send an SCS request frame to the associated AP to report the low-latency traffic stream, and indicate a quality of service (QOS) parameter of the traffic stream. After receiving the SCS request frame, the AP replies with an SCS response frame. The SCS response frame may be used to notify the STA whether the AP accepts the low-latency traffic stream reported by the STA. The following separately describes frame structures of the SCS request frame and the SCS response frame. The low-latency traffic stream in the present disclosure is also referred to as an SCS stream.

FIG. 6 is a schematic diagram of a frame format of the SCS request frame according to an embodiment of the present disclosure. As shown in FIG. 6, the SCS request frame includes a category field, a robust action field, a dialog token field, and an SCS descriptor element list field. The category field indicates a category to which the action frame belongs, the robust action field indicates a frame in the category, and the SCS descriptor element list field includes one or more SCS descriptor elements.

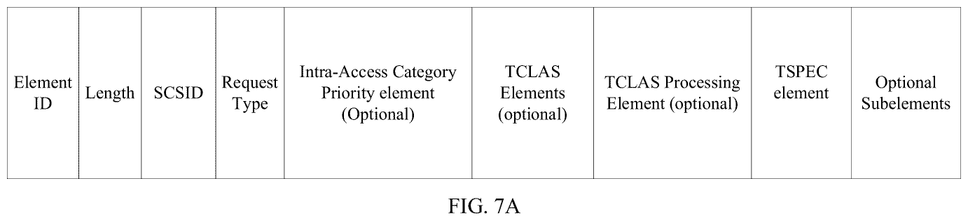

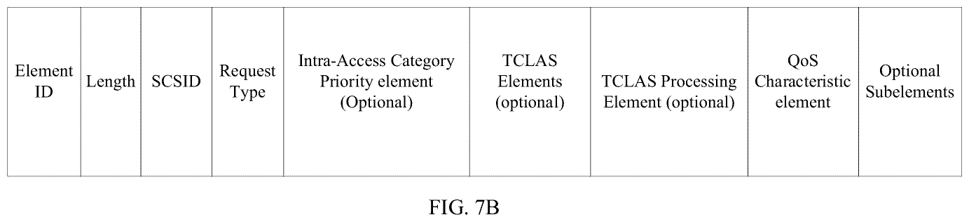

FIG. 7A is a schematic diagram of a frame format of the SCS descriptor element according to an embodiment of the present disclosure. As shown in FIG. 7A, the SCS descriptor element includes an element identifier field, a length field, an SCS identifier field, a request type field, an intra-access category priority element field (optional), a traffic classification elements field (optional), a traffic classification processing element field (optional), a traffic specification element field, and the like. FIG. 7B is a schematic diagram of another frame format of the SCS descriptor element according to an embodiment of the present disclosure. As shown in FIG. 7B, the SCS descriptor element includes an element identifier field, a length field, an SCS identifier field, a request type field, an intra-access category priority element field (optional), a traffic classification elements field (optional), a traffic classification processing element field (optional), a QoS characteristic element field, and the like.

The 1-octet SCSID field indicates an identifier allocated to the SCS stream. The 1-octet request type field indicates a requested type. For example, when the request type field is set to 0, it indicates increase; when the request type field is set to 1, it indicates removal; and when the request type field is set to 2, it indicates change. The traffic classification (TCLAS) elements field indicates how to identify the SCS stream, and the traffic classification elements field carries a criterion for determining the SCS stream. The TCLAS processing element field indicates how to process a plurality of traffic classification elements when the plurality of traffic classification elements exist. The traffic specification (TSPEC) element field or the QoS characteristic element field indicates information such as a TID mapped to a corresponding SCS stream and a corresponding QoS parameter. Two most important QoS parameters include a delay bound indicating a maximum delay allowed by a low-delay packet and a packet delivery ratio indicating a required packet delivery ratio under a given delay bound requirement.

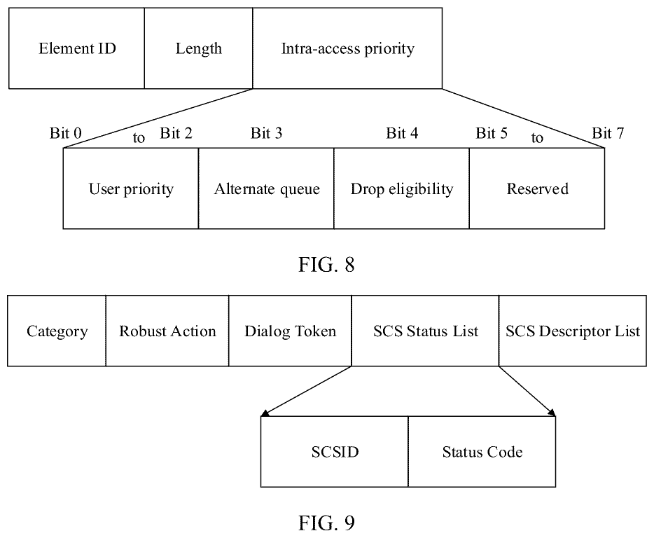

FIG. 8 is a schematic diagram of a frame format of the intra-access category priority element field according to an embodiment of the present disclosure. As shown in FIG. 8, the intra-access category priority element field includes an element identifier field, a length field, and a 1-octet intra-access priority field. The intra-access priority field includes a 3-bit (bit 0 to bit 2) user priority subfield, a 1-bit (bit 3) alternate queue subfield, and a 1-bit (bit 4) drop eligibility subfield. The user priority subfield indicates a user priority, the alternate queue subfield indicates whether a new alternate queue is set up for the SCS stream, and the drop eligibility subfield indicates whether a data packet of the SCS stream can be discarded when resources are insufficient.

FIG. 9 is a schematic diagram of a frame format of the SCS response frame according to an embodiment of the present disclosure. As shown in FIG. 9, the SCS response frame includes a category field, a robust action field, a dialog token field, an SCS status list field, and an SCS descriptor element list field. The category field indicates a category to which the action frame belongs, and the robust action field indicates a frame in the category. The dialog token field in the SCS response frame needs to be consistent with the dialog token field in the corresponding SCS request frame. The SCS status list field includes one or more SCS status groups. One SCS status group is indicated by two subfields, and the two subfields include an SCSID subfield indicating an identifier of the SCS stream and a status code subfield indicating whether a requested SCSID is accepted. The SCS descriptor element list field includes one or more SCS descriptor elements.

### 3. Traffic Identifier (TID) and Access Category (AC)

A length of the TID is 4 bits (Bits), and the traffic identifier indicates a priority corresponding to traffic. In enhanced distributed channel access (EDCA), a value range of a TID is 0 to 7, and 8 to 15 are reserved values.

Four access categories (ACs) are defined in the 802.11 protocol. Each access category defines different parameters such as an arbitration inter-frame spacing number (AIFSN) and a contention window size, and determines a priority during channel access. As shown in the following Table 2, Table 2 shows parameters such as a contention window size and an arbitration inter-frame spacing number that correspond to each access category.

TABLE 2

| | | | Arbitration | |
|---|---|---|---|---|
| | Minimum | Maximum | inter-frame | |
| | contention | contention | spacing | |
| | window | window | number | TXOP limit |
| Access | (CWmin) | (CWmax) | (AIFSN) | (millisecond |
| category/AC | (slots) | (slots) | (slots) | (ms)) |
| AC_BK | 31 | 1023 | 7 | 0 |
| (background\) | | | | |
| AC_BE (best | 31 | 1023 | 3 | 0 |
| effort) | | | | |
| AC_VI (video) | 15 | 31 | 2 | 3.008 ms |
| AC_VO (voice) | 7 | 15 | 2 | 1.504 ms |
| Legacy | 15 | 1023 | 2 | 0 |

### 4. TID-to-Link Mapping

If a non-AP MLD wants to perform TID-to-link mapping negotiation with an associated AP MLD, the non-AP MLD may send a TID-to-link mapping request frame. After receiving the TID-to-link mapping request frame, the AP MLD may reply with a TID-to-link mapping response frame. Information included in the TID-to-link mapping request frame is shown in the following Table 3. Information included in the TID-to-link mapping response frame is shown in the following Table 4. In addition, in 802.11be, TID-to-link mapping negotiation is alternatively supported by carrying a TID-to-link mapping element in an (re)association request/response ((Re)Association Request/Response) frame.

TABLE 3
Frame format of the TID-to-link mapping request frame

| Order | Information |
|---|---|
| 1 | Category |
| 2 | EHT Action |
| 3 | Dialog Token |
| 4 | TID-to-link mapping element |

TABLE 4
Frame format of the TID-to-link mapping response frame

| Order | Information |
|---|---|
| 1 | Category |
| 2 | EHT Action |
| 3 | Dialog Token |
| 4 | Status Code |
| 5 | TID-to-link mapping element |

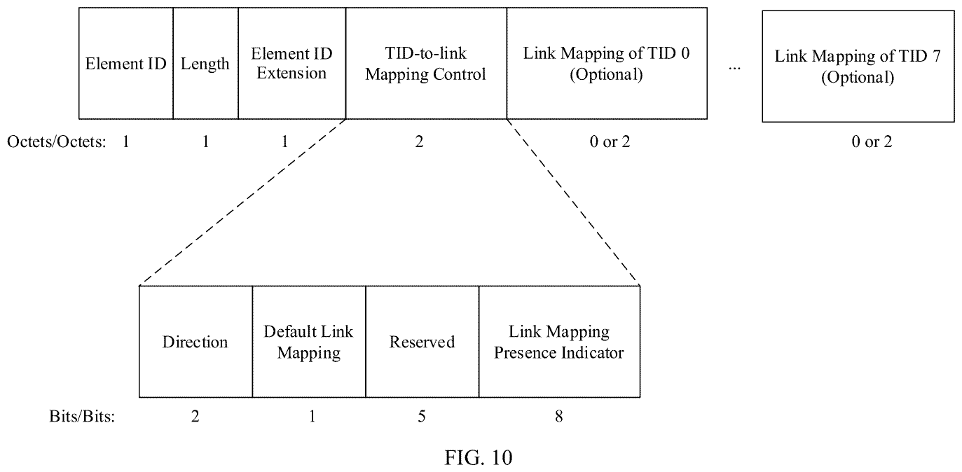

FIG. 10 is a schematic diagram of a frame format of the TID-to-link mapping element according to an embodiment of the present disclosure. As shown in FIG. 10, the TID-to-link mapping element includes an element identifier field, a length field, an element identifier extension field, a TID-to-link mapping control field, and the like. The TID-to-link mapping control field includes a direction subfield, a default link mapping bit, and a link mapping presence indicator subfield. When the direction subfield is set to 0, it indicates an uplink. When the direction subfield is set to 1, it indicates a downlink. When the direction subfield is set to 2, it indicates an uplink and a downlink. When the direction subfield is set to 3, 3 is a reserved value. The default link mapping bit indicates whether to map all TIDs to all links. When the default link mapping bit is set to 1, it indicates that all the TIDs are mapped to all the links. For example, it is assumed that there are three links between the non-AP MLD and the AP MLD: link 1, link 2, and link 3. When the default link mapping bit is set to 1, it indicates that TIDs 0 to 7 are mapped to the link 1, the TIDs 0 to 7 are mapped to the link 2, and the TIDs 0 to 7 are mapped to the link 3. The link mapping presence indicator field indicates link mapping corresponding to each TID (namely, Link Mapping of TID #n, where n ranges from 0 to 7). When the default link mapping bit is set to 1, the link mapping presence indicator field is reserved or unused. When link mapping of TID #n exists in the TID-to-link mapping element, link mapping of TID #n indicates whether the TID #n is mapped to a corresponding link. When a corresponding bit is set to 1, it indicates that the TID #n is mapped to the corresponding link.

### 5. QoS Map Element

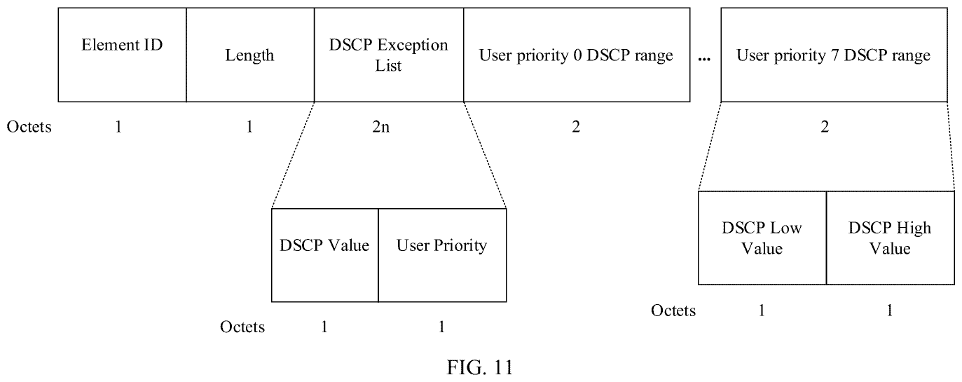

The QoS map element may be carried in an association response frame or a reassociation response frame. FIG. 11 is a schematic diagram of a frame format of the QoS map element according to an embodiment of the present disclosure. As shown in FIG. 11, the QoS map element includes an element identifier field, a length field, a DSCP exception list field, and a user priority #n (n ranges from 0 to 7) DSCP range field. The DSCP exception list field may carry one or more DSCP exception fields. Each DSCP exception field includes the following subfields: DSCP value subfield that ranges from 0 to 63 or from 0 to 255 and user priority subfield whose value ranges from 0 to 7. Each user priority has a corresponding DSCP range field, and DSCP ranges corresponding to all user priorities do not overlap. The user priority #n (n ranges from 0 to 7) DSCP range field includes the following subfields: DSCP low value subfield and DSCP high value subfield, where a DSCP high value is greater than or equal to a DSCP low value. If the DSCP low value subfield and the DSCP high value subfield are both set to 255, the priority is not used.

### 6. Reduced Neighbor Report (RNR) Element

An AP may send a management frame, for example, a beacon frame or a probe response frame, carrying an RNR element. During scanning, a STA receives the beacon frame or the probe response frame sent by the AP to obtain information about surrounding APs, and then selects an appropriate AP for association.

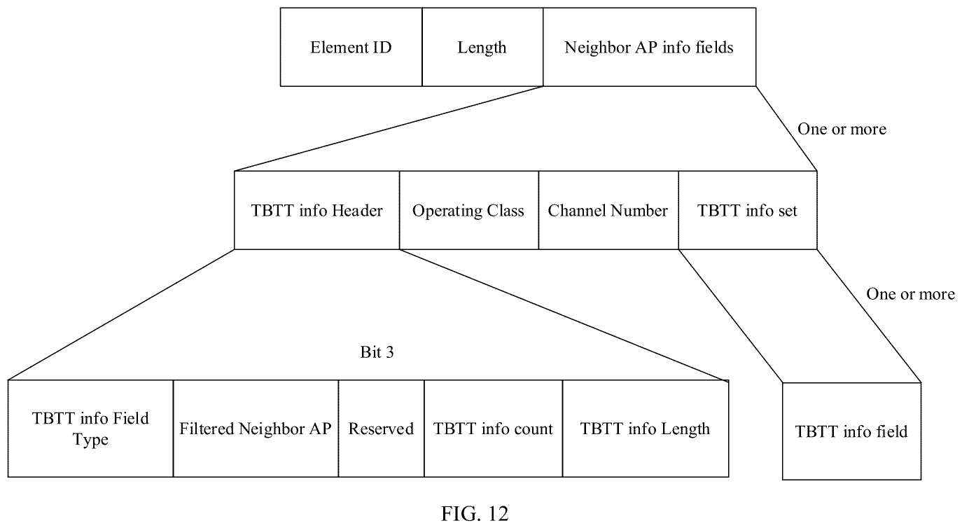

FIG. 12 is a schematic diagram of a frame format of the RNR element according to an embodiment of the present disclosure. As shown in FIG. 12, the RNR element includes an element identifier field, a length field, and one or more neighbor AP information fields. Each neighbor AP information field includes a target beacon transmission time (TBTT) information header field, an operating class field, a channel number field, and a TBTT information set field. The operating class field indicates an operating class of a reported operating channel of a corresponding AP, and other values such as 0 and 255 are reserved values. The channel number field indicates a channel number corresponding to the reported operating channel of the corresponding AP. When the channel number field is set to 0, it indicates a reserved value. The STA may determine a specific location of the channel of the AP in a frequency band by using the operating class field and the channel number field.

The TBTT information header field includes a TBTT information field type field, a filtered neighbor AP field, a reserved bit, a TBTT information count field, and a TBTT information length field. The TBTT information field type field indicates a TBTT information type. The TBTT information field type field and the TBTT info length field jointly indicate a format of a TBTT information field, and 1, 2, and 3 are reserved values. The filtered neighbor AP field indicates whether service set identifiers (SSIDs) of all BSSs that are carried in the neighbor AP information field match an SSID in a probe request frame. The TBTT information count field indicates a quantity of TBTT information fields included in the TBTT information set. The TBTT information length field indicates a length of each TBTT information field. The following Table 5 shows formats of specific carried information of different lengths.

TABLE 5

| TBTT information | |
|---|---|
| length (octets) | Content carried in the TBTT information field |
| 1 | Neighbor AP TBTT offset (offset) field |
| 2 | Neighbor AP TBTT offset field and BSS parameters field |
| 4 | Neighbor AP TBTT offset field and MLD parameters field |
| 5 | Neighbor AP TBTT offset field and short SSID field |
| 6 | Neighbor AP TBTT offset field, short SSID field, and BSS parameters |
| | field |
| 7 | Neighbor AP TBTT offset field and BSSID field |
| 8 | Neighbor AP TBTT offset field, BSSID field, and BSS parameters field |
| 9 | Neighbor AP TBTT offset field, BSSID field, BSS parameters field, and |
| | 20 MHz power spectral density (PSD) field |
| 10 | Neighbor AP TBTT offset field, BSSID field, and MLD parameters field |
| 11 | Neighbor AP TBTT offset field, BSSID field, and short SSID field |
| 12 | Neighbor AP TBTT offset field, BSSID field, short SSID field, and BSS |
| | parameters field |
| 0, 3, 14, and 15 | Reserved |
| 13 | Neighbor AP TBTT offset field, BSSID field, short SSID field, BSS |
| | parameters field, and 20 MHz PSD field |
| 16 | Neighbor AP TBTT offset field, BSSID field, short SSID field, BSS |
| | parameters field, 20 MHz PSD field, and MLD parameters field |
| 17-255 | Reserved, where the first 16 octets contain same information as when a |
| | length of the TBTT information field is 16. |

The TBTT information set field includes one or more TBTT information fields. For a specific format of the TBTT information field, refer to descriptions in an existing standard.

### 7. Basic Service Set (BSS) Transition Management (BTM) Action Frame

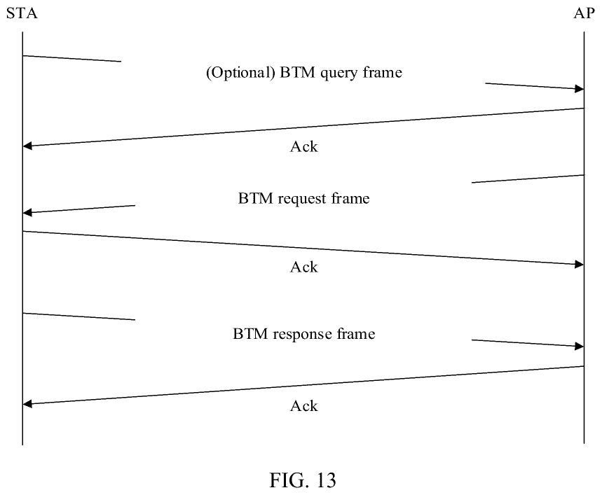

When finding that link quality is poor or another reason, a STA already associated with an AP may send a BTM query frame to the associated AP. For a specific frame format of the BTM query frame, refer to descriptions in an existing standard. FIG. 13 is a schematic diagram of a BTM operation procedure according to an embodiment of the present disclosure. As shown in FIG. 13, when an AP wants a STA to perform BSS transition, the AP may send a BTM request frame to the STA. The STA may reply with a BTM response frame to indicate whether to accept or reject a BSS transition request.

### 8. TXOP Sharing (TXS)

Because a Wi-Fi (or 802.11) system is deployed on an unlicensed spectrum, stations (stations in a broad sense, to be specific, APs and STAs) need to use channel resources through contention. In a common EDCA contention mechanism, a station sends a first frame (for example, a request to send (RTS) frame) after completing channel backoff. If the first frame has a response frame, it indicates that channel contention succeeds after the response frame is successfully received. Otherwise, backoff needs to be performed again. If the first frame (for example, a clear to send (CTS)-to-self frame) does not require the response frame, channel contention succeeds after the first frame is sent. After channel contention succeeds, the station may reserve a period of time for data transmission, and the period of time is referred to as a TXOP. The station that successfully reserves the TXOP is referred to as a TXOP holder. In the TXOP, only the TXOP holder can actively send data, and another station can only receive data or send a corresponding response frame.

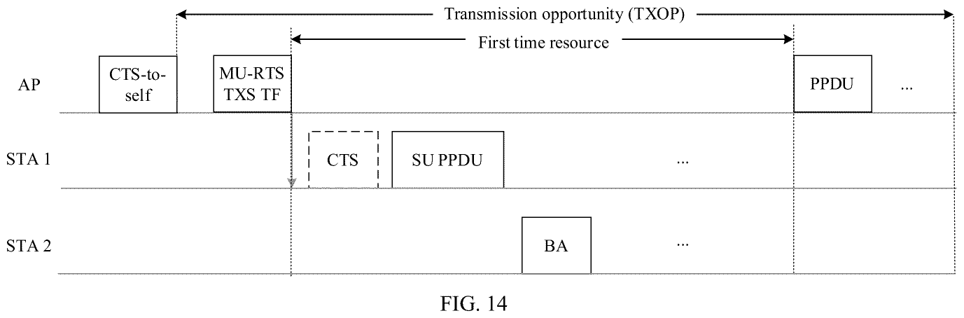

In the 802.11be standard, a TXOP mechanism is extended, to be specific, an AP serving as a TXOP holder may allocate a part of time resources in a TXOP to a first station, and the first station may perform peer-to-peer (P2P) transmission with a second station or send uplink data to the AP in allocated time. This mechanism is referred to as TXOP sharing. FIG. 14 is a schematic diagram of TXOP sharing according to an embodiment of the present disclosure. As shown in FIG. 14, an AP obtains a TXOP after sending a CTS-to-self frame, and may allocate a first time resource in a TXOP to a STA 1, and the STA 1 performs P2P transmission with a STA 2 in allocated time. This mechanism can be used to reduce collision caused by channel contention by the first station (for example, the STA 1 in FIG. 14), and improve system efficiency. A P2P link used for P2P transmission herein is set up by two non-AP STAs through tunneled direct link setup (TDLS) or by using another P2P protocol. In some scenarios, P2P may also be referred to as device-to-device (D2D), TDLS, or the like. P2P, D2D, TDLS, and the like are essentially the same.

To better support transmission of a low-latency service, although an enhanced link subset mapping scheme is proposed, some problems still exist in the scheme, for example, 1: how to set up a link (namely, a clean link) to which only a TID corresponding to the low-latency service is allowed to be mapped, to prevent the low-latency service on the link from being interfered by a non-low-latency service, and 2: how to indicate the TID that can be used by only the low-latency service, to distinguish the low-latency service from the non-low-latency service by using the TID.

Therefore, embodiments of the present disclosure provide a multi-link communication method. An unassociated non-AP MLD is disallowed to initiate multi-link setup on a clean link, to prevent a case in which only the clean link is successfully set up between the non-AP MLD and an AP MLD. Therefore, a low-latency service on the clean link is not interfered by a non-low-latency service. In addition, in the multi-link communication method provided in embodiments of the present disclosure, TID space (0 to 7) may be further divided into two parts. One part is used for non-low-latency services, and the other part is used for low-latency services, and a STA is notified of the two parts by using a QoS map element. In a subsequent data transmission process, a low-latency service may be distinguished from a non-low-latency service by using a TID.

The technical solutions provided in the present disclosure are described by using a plurality of embodiments. Embodiment 1 provides description of defining a new access control mode by using a supported rates and BSS membership selectors element. In this mode, only the non-AP MLD is allowed to set up the link (the clean link) only by initiating multi-link setup on another link. Embodiment 2 describes how to perform an operation when the AP MLD wants to use a link as a clean link at a moment after association. Embodiment 3 provides description that an AP or the AP MLD maps DSCP space 0 to 63 to a subset of the TIDs (0 to 7) by using the QoS map element, and the remaining TIDs can be used for only low-latency services. Embodiment 4 provides description that the non-AP MLD performs TID-to-link mapping negotiation according to an SCS mechanism. Embodiment 5 describes an access policy for indicating a traffic stream in a QoS characteristic element.

In the present disclosure, unless otherwise specified, for same or similar parts of embodiments or implementations, refer to each other. In embodiments of the present disclosure and the implementations/implementation methods in embodiments, unless otherwise specified or a logical conflict occurs, terms and/or descriptions are consistent and may be mutually referenced between different embodiments and between the implementations/implementation methods in embodiments. Technical features in the different embodiments and the implementations/implementation methods in embodiments may be combined to form a new embodiment, implementation, or implementation method based on an internal logical relationship thereof. The following implementations of the present disclosure are not intended to limit the protection scope of the present disclosure.

In the present disclosure, “a link on which only a low-latency service is allowed to be transmitted” or “a link to which only a TID corresponding to a low-latency service is allowed to be mapped” is referred to as a “clean link (clean link)”. Certainly, another name may be used. This is not limited in the present disclosure.

The “user priority” and the “TID” are not distinguished in the present disclosure. There is a one-to-one correspondence between the “user priority” and the “TID”, and the “user priority” and the “TID” may be used alternatively. A user priority 0 corresponds to a TID 0, a user priority 1 corresponds to a TID 1, a user priority 2 corresponds to a TID 2, a user priority 3 corresponds to a TID 3, a user priority 4 corresponds to a TID 4, a user priority 5 corresponds to a TID 5, a user priority 6 corresponds to a TID 6, and a user priority 7 corresponds to a TID 7.

For octets of each frame and bits or octets of each field in each frame mentioned in the present disclosure, refer to descriptions in the existing standard. Details are not described again in the present disclosure.

The following describes each embodiment in detail.

### Embodiment 1

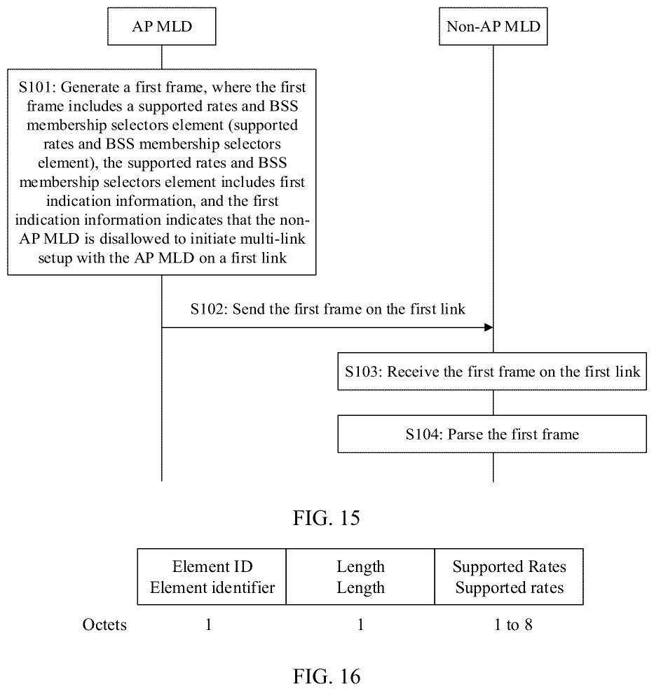

FIG. 15 is a first schematic flowchart of a multi-link communication method according to an embodiment of the present disclosure. The multi-link communication method is mainly used in a multi-link setup process or before multi-link setup. As shown in FIG. 15, the multi-link communication method includes but is not limited to the following steps.

S101: An AP MLD generates a first frame, where the first frame includes a supported rates and BSS membership selectors element, the supported rates and BSS membership selectors element includes first indication information, and the first indication information indicates that a non-AP MLD is disallowed to initiate multi-link setup with the AP MLD on a first link.

S102: The AP MLD sends the first frame on the first link.

S103: The non-AP MLD receives the first frame on the first link.

S104: The non-AP MLD parses the first frame.

Optionally, in this embodiment of the present disclosure, the AP MLD has at least two links, and the at least two links include the first link and a second link. The first link is a link on which only a low-latency service is allowed to be transmitted or a link to which only a TID corresponding to a low-latency service is allowed to be mapped, that is, the first link is a clean link. The clean link in this embodiment of the present disclosure may be one link or a plurality of links. This is not limited in embodiments of the present disclosure.

Optionally, the first frame in this embodiment of the present disclosure is a frame sent on the first link. The first frame may be any one of the following frames: a beacon frame, a probe response frame, an association response frame, or a reassociation response frame. The first frame may carry the supported rates and BSS membership selectors element. The supported rates and BSS membership selectors element is used to carry a condition (for example, a rate or a BSS membership selector) that needs to be met to join a BSS (a BSS formed by an AP operating on the first link in the AP MLD). In other words, a STA is allowed to join the BSS only when the STA meets the condition indicated by the supported rates and BSS membership selectors element. The supported rates and BSS membership selectors element includes the first indication information, and the first indication information may indicate that the non-AP MLD is disallowed to initiate multi-link setup with the AP MLD on the first link. For ease of description, in the present disclosure, that the non-AP MLD is disallowed to initiate multi-link setup with the AP MLD on a link (or a clean link) is referred to as restricted multi-link setup.

Optionally, the first indication information may be that the BSS membership selector in the supported rates and BSS membership selectors element is set to a preset value, for example, 120, 121, or another unused value. In other words, in this embodiment of the present disclosure, the BSS membership selector in the supported rates and BSS membership selectors element is set to the preset value (for example, 120, 121, or the another unused value), to indicate that the non-AP MLD is disallowed to initiate multi-link setup with the AP MLD on the first link. In other words, when the BSS membership selector is set to the preset value, it indicates that the non-AP MLD can perform only restricted multi-link setup. To be specific, the non-AP MLD can initiate multi-link setup only through another link (a link other than the clean link) to set up the link (the clean link).

FIG. 16 is a schematic diagram of a frame format of the supported rates and BSS membership selectors element according to an embodiment of the present disclosure. The supported rates and BSS membership selectors element can specify any combination of up to eight BSS membership selectors and rates. As shown in FIG. 16, the supported rates and BSS membership selectors element includes an element identifier field, a length field, and a supported rates field. Each octet of the supported rates field is used to describe a supported rate or a BSS membership selector of a single BSS member. Because the BSS membership selector and the supported rate are carried in a same field, a value of the BSS membership selector is disallowed to be the same as a value corresponding to any valid supported rate. In other words, a value represents either the supported rate or the BSS membership selector.

When a beacon frame, a probe response frame, or a (Re)association response frame carry a supported rates and BSS membership selectors element, each rate in a BSS basic rate set parameter is encoded according to the following rule: The most significant bit (bit 7) of each octet is set to 1, and the remaining 7 bits are set in a unit of 500 kilobytes (Kb)/second (s). Each rate in an optional rate set parameter is encoded according to the following rule: The most significant bit (bit 7) of each octet is set to 0, and the remaining 7 bits are set in a unit of 500 Kb/s.

When the beacon frame, the probe response frame, or the (Re)association response frame carry the supported rates and BSS membership selectors element, each BSS membership selector in a BSS membership selector set parameter is encoded according to the following rule: The most significant bit (bit 7) of each octet is set to 1, and the remaining 7 bits are set according to the following Table 6:

TABLE 6
Valid value of a BSS membership selector

| Value | Characteristic | Interpretation |
|---|---|---|
| 127 | High Throughput (HT) PHY | The HT PHY needs to be supported |
| 126 | Very High Throughput (VHT) | The VHT PHY needs to be supported |
| | PHY | |
| 125 | General Link (GLK) | A GLK feature needs to be supported |
| 124 | EtherType protocol | EPD needs to be supported |
| | discrimination (EPD) | |
| 123 | Simultaneous Authentication | SAE hash-to-element only needs to be supported |
| | Of Equals (SAE) Hash-to- | |
| | Element Only | |
| 122 | High Efficiency (HE) PHY | The HE PHY needs to be supported |
| 121 | Extremely high throughput | The EHT PHY needs to be supported |
| | (EHT) PHY | |
| 120 | Restricted multi-link setup | The non-AP MLD can initiate multi-link setup only |
| | | through another link (a link other than the clean |
| | | link) to set up the link (the clean link). |

As shown in Table 6, when the BSS membership selector is set to 127, it indicates that a station that wants to join the BSS needs to support the HT PHY. When the BSS membership selector is set to 126, it indicates that a station that wants to join the BSS needs to support the VHT PHY. When the BSS membership selector is set to 125, it indicates that a station that wants to join the BSS needs to support the GLK feature. When the BSS membership selector is set to 124, it indicates that a station that wants to join the BSS needs to support EPD. When the BSS membership selector is set to 123, it indicates that a station that wants to join the BSS needs to support the SAE hash-to-element only. When the BSS membership selector is set to 122, it indicates that a station that wants to join the BSS needs to support the HE PHY. When the BSS membership selector is set to 121, it indicates that a station that wants to join the BSS needs to support the EHT PHY. When the BSS membership selector is set to 120, it indicates that a non-AP MLD that wants to join the BSS can initiate multi-link setup only through another link (a link other than the clean link). Certainly, alternatively, when the BSS membership selector is set to 120, it indicates that a station that wants to join the BSS needs to support the EHT PHY. When the BSS membership selector is set to 121, it indicates that a non-AP MLD that wants to join the BSS can initiate multi-link setup only through another link (a link other than the clean link). Certainly, alternatively, when the BSS membership selector is set to another unused value, it indicates that a non-AP MLD that wants to join the BSS can initiate multi-link setup only through another link, or it indicates that a station that wants to join the BSS needs to support the EHT PHY.

Optionally, the supported rates and BSS membership selectors element may specify up to the eight BSS membership selectors. Therefore, the supported rates and BSS membership selectors element may include a plurality of BSS membership selectors at the same time, and the plurality of BSS membership selectors may be set to different values. For example, the supported rates and BSS membership selectors element includes two BSS membership selectors. When one BSS membership selector is set to 127, it indicates that a station that wants to join the BSS needs to support the HT PHY. When the other BSS membership selector is set to 125, it indicates that the station that wants to join the BSS needs to support the GLK feature. In other words, the station that joins the BSS needs to support both the HT PHY and the GLK feature.

It may be understood that a next-generation standard is compatible with a previous standard. To be specific, a station supporting a VHT protocol also supports a protocol earlier than the VHT, for example, an HT protocol; a station supporting an HE protocol also supports the VHT and HT protocols; and a station supporting an EHT protocol also supports the HT, VHT, and HE protocols.

It should be understood that when the BSS membership selector is set to the preset value (for example, 120, 121, or the another unused value), a legacy STA considers that it does not meet the condition of joining the BSS (the BSS formed by the AP operating on the first link/clean link in the AP MLD) because the legacy STA cannot understand the preset value. Therefore, the legacy STA does not associate with the AP operating on the first link/clean link in the AP MLD. In other words, the legacy STA cannot perform association on the first link/clean link.

The legacy STA in the present disclosure is a station supporting only a protocol earlier than an 802.11be protocol, for example, an HE station supporting an 802.11ax protocol, a VHT station supporting an 802.11ac protocol, or an HT station supporting an 802.11n protocol.

Similar to the legacy STA, when the BSS membership selector is set to the preset value (for example, 120, 121, or the another unused value), if a single-link station (single-link EHT STA) supporting an extremely high throughput protocol cannot understand the preset value, the single-link EHT STA cannot perform association on the first link/clean link, either.

Optionally, if the single-link EHT STA can understand the preset value, the first indication information further indicates that the single-link EHT STA is disallowed to set up association with the AP MLD on the first link/clean link. In other words, if the single-link EHT STA can understand the preset value set in the present disclosure, when the BSS membership selector in the supported rates and BSS membership selectors element is set to the preset value, it indicates that the non-AP MLD is disallowed to initiate multi-link setup with the AP MLD on the first link (or the clean link), and it further indicates that the single-link EHT STA is disallowed to set up association with the AP MLD on the first link (or the clean link).

Optionally, when the first frame is the beacon frame (even if the non-AP MLD sends a probe request frame and/or an association request frame on the first link), the AP MLD is disallowed to reply with a (corresponding) probe response frame and/or association response frame on the first link. In other words, when the first frame is the beacon frame, the AP MLD does not reply with the probe response frame or the association response frame on the clean link. When the first frame is the probe response frame, the AP MLD is disallowed to reply with an association response frame on the first link. In other words, when the first frame is the probe response frame (even if the non-AP MLD sends an association request frame on the first link), the AP MLD does not reply with the association response frame on the clean link. When the first frame is any one of the beacon frame, the probe response frame, the association response frame, or the reassociation response frame, the AP MLD may reject this association (sent on the first link) by using a status code field in the association response frame or the reassociation response frame.

Optionally, because the AP MLD may send a beacon frame or a probe response frame on each link of the AP MLD, the multi-link communication method further includes: The AP MLD sends a beacon frame or a probe response frame on the second link. Correspondingly, the non-AP MLD receives the beacon frame or the probe response frame on the second link. The beacon frame or the probe response frame includes an RNR element. For a frame format of the RNR element, refer to the foregoing FIG. 12. The RNR element includes a neighbor AP information field corresponding to a first AP, and a channel number field in the neighbor AP information field is set to 0. The first AP is an AP operating on the first link in the AP MLD.

According to 802.11be, an affiliated AP of the AP MLD needs to use the RNR element to carry corresponding information of another affiliated AP of the same AP MLD. Because the first AP disallows the legacy STA to perform association, in this embodiment of the present disclosure, the channel number field corresponding to the first AP in the RNR element is set to 0. In this way, the legacy STA cannot discover the first AP by using the RNR element, and does not switch to a corresponding channel to attempt association. It is equivalent that in the RNR element, the first AP is invisible to the legacy STA.

It should be understood that, if the first frame is the beacon frame, the AP MLD may send the beacon frame on the second link when the step S102 is performed, or the AP MLD may send the beacon frame on the second link before the step S102 is performed, or the AP MLD may send the beacon frame or the probe response frame on the second link after the step S102 is performed. If the first frame is the probe response frame, the AP MLD may send the probe response frame on the second link when the step S102 is performed, or the AP MLD may send the beacon frame or the probe response frame on the second link before the step S102 is performed, or the AP MLD may send the probe response frame on the second link after the step S102 is performed. If the first frame is the association response frame or the reassociation response frame, the AP MLD may send the beacon frame or the probe response frame on the second link before the step S102 is performed.

To better understand the multi-link communication method in this embodiment of the present disclosure, the following uses two examples for description.

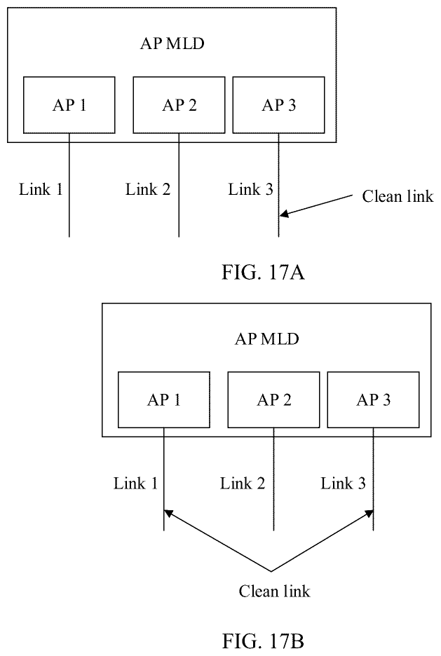

Example 1: FIG. 17A is a schematic diagram of a clean link in the AP MLD according to an embodiment of the present disclosure. As shown in FIG. 17A, the AP MLD has three links in total: a link 1, a link 2, and a link 3. It is assumed that the AP MLD wants to set the link 3 as the clean link, and the link 1 and the link 2 allow a legacy STA to associate.

Therefore, for a beacon frame/probe response frame to be sent on the link 1, the AP MLD sets a BSS membership selector in a supported rates and BSS membership selectors element of the AP MLD to 127, sets a channel number field corresponding to an AP 2 in an RNR element to a real value, and sets a channel number field corresponding to an AP 3 in the RNR element to 0. It should be understood that the real value herein is a real channel number corresponding to the AP.

For a beacon frame/probe response frame to be sent on the link 2, the AP MLD sets a BSS membership selector in a supported rates and BSS membership selectors element to 127, sets a channel number field corresponding to an AP 1 in an RNR element to a real value, and sets the channel number field corresponding to the AP 3 in the RNR element to 0.

For a beacon frame/probe response frame to be sent on the link 3, the AP MLD sets a BSS membership selector in a supported rates and BSS membership selectors element to 120, sets the channel number field corresponding to the AP 1 in an RNR element to the real value, and also sets the channel number field corresponding to the AP 2 in the RNR element to the real value.

When a station on the link 3 is a legacy STA, the legacy STA does not attempt to initiate association when the legacy STA learns that the BSS membership selector is an unknown value (for example, 120). When a station on the link 3 belongs to the non-AP MLD and a value of the BSS membership selector read by the non-AP MLD is 120, the non-AP MLD redirects to other links (such as the link 1 and the link 2) of the AP MLD to attempt to initiate association.

Example 2: FIG. 17B is another schematic diagram of clean links in the AP MLD according to an embodiment of the present disclosure. As shown in FIG. 17B, the AP MLD has three links in total: a link 1, a link 2, and a link 3. It is assumed that the AP MLD wants to set the link 1 and the link 3 as the clean links, and the link 2 allows a legacy STA to associate.

Therefore, for a beacon frame/probe response frame to be sent on the link 1, the AP MLD sets a BSS membership selector in a supported rates and BSS membership selectors element of the AP MLD to 120, sets a channel number field corresponding to an AP 2 in an RNR element to a real value, and sets a channel number field corresponding to an AP 3 in the RNR element to 0.

For a beacon frame/probe response frame to be sent on the link 2, the AP MLD sets a BSS membership selector in a supported rates and BSS membership selectors element of the AP MLD to 127, sets a channel number field corresponding to an AP 1 in an RNR element to 0, and also sets the channel number field corresponding to the AP 3 in the RNR element to 0.

For a beacon frame/probe response frame to be sent on the link 3, the AP MLD sets a BSS membership selector in a supported rates and BSS membership selectors element of the AP MLD to 120, sets the channel number field corresponding to the AP 1 in an RNR element to 0, and sets the channel number field corresponding to the AP 2 in the RNR element to the real value.

When a station on the link 1 and/or the link 3 is a legacy STA, the legacy STA does not attempt to initiate association when the legacy STA learns that the BSS membership selector is an unknown value (for example, 120). When a station on the link 1 and/or the link 3 belongs to the non-AP MLD and a value of the BSS membership selector read by the non-AP MLD is 120, the non-AP MLD redirects to another link (for example, the link 2) of the AP MLD to attempt to initiate association.

It should be understood that, if the non-AP MLD initiates multi-link setup through the clean link, it is possible that the non-AP MLD successfully sets up only the link (namely, the clean link) with the AP MLD. In this case, the non-AP MLD may have the low-latency service and a non-low-latency service on the link. Therefore, the link cannot be used to transmit only the low-latency service. If the non-AP MLD initiates multi-link setup through the clean link, channel resources of the clean link are occupied, which may cause interference to a low-latency service being transmitted on the clean link.

Therefore, in this embodiment of the present disclosure, the indication information is carried in the supported rates and BSS membership selectors element, to indicate that the non-AP MLD is disallowed to initiate multi-link setup on the clean link, and the non-AP MLD needs to set up the link through another link of the AP MLD. In addition, it is restricted that the single-link EHT STA cannot associate with the affiliated AP on the clean link, and the legacy STA also cannot set up association with the affiliated AP on the clean link because the legacy STA cannot identify the indication information. Therefore, the low-latency service on the clean link is not interfered by the non-low-latency service.

In addition, the AP MLD in this embodiment of the present disclosure may comprehensively consider a QoS requirement of the low-latency service, a quantity of legacy STAs, and a quantity of single-link EHT STAs, to flexibly and dynamically control a quantity of clean links and TID-to-link mapping. In addition, because there is no legacy STA or single-link EHT STA, an operation of the AP MLD on the clean link is simple and flexible.

### Embodiment 2

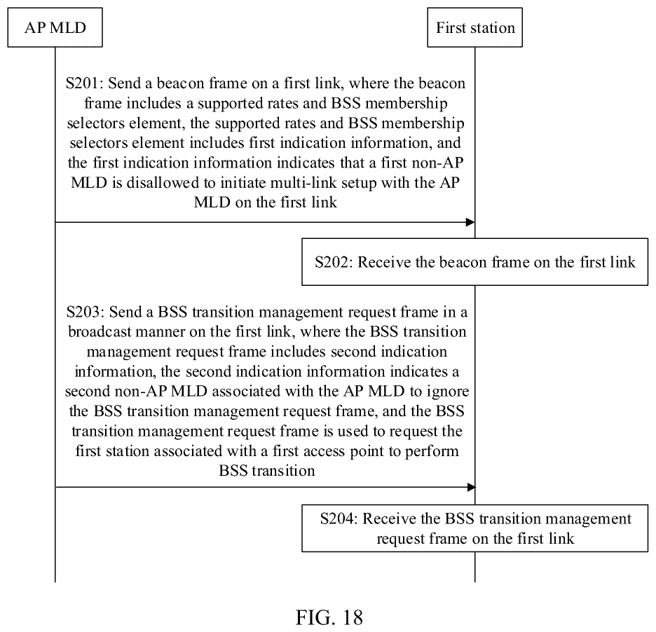

FIG. 18 is a second schematic flowchart of a multi-link communication method according to an embodiment of the present disclosure. The multi-link communication method is mainly used after multi-link setup or after an association process. As shown in FIG. 18, the multi-link communication method includes but is not limited to the following steps.

S201: An AP MLD sends a beacon frame on a first link, where the beacon frame includes a supported rates and BSS membership selectors element, the supported rates and BSS membership selectors element includes first indication information, and the first indication information indicates that a first non-AP MLD is disallowed to initiate multi-link setup with the AP MLD on the first link.

Optionally, in this embodiment of the present disclosure, the AP MLD has at least two links, and the at least two links include the first link and a second link. In the association process, a legacy STA is allowed to associate with a single-link EHT STA on both the first link and the second link of the AP MLD, and a non-AP MLD is also allowed to initiate multi-link setup on the first link and the second link. However, after association succeeds, the AP MLD wants to use, at a moment, the first link as a link on which only a low-latency service is allowed to be transmitted or a link to which only a TID corresponding to a low-latency service is allowed to be mapped.

In this case, the AP MLD may send the beacon frame on the first link, and the beacon frame may carry the supported rates and BSS membership selectors element. The supported rates and BSS membership selectors element includes the first indication information, and the first indication information may indicate that a non-AP MLD (denoted as the first non-AP MLD) that is not associated with the AP MLD is disallowed to initiate multi-link setup with the AP MLD on the first link. Optionally, the AP MLD further is disallowed to reply with a probe response frame and/or an association response frame on the first link. For an implementation of the first indication information, refer to the corresponding descriptions in Embodiment 1. A frame format of the supported rates and BSS membership selectors element is shown in FIG. 16, and details are not described herein again.

Optionally, the multi-link communication method further includes: The AP MLD may further send a beacon frame or a probe response frame on the second link, where the beacon frame or the probe response frame includes an RNR element. For a frame format of the RNR element, refer to the foregoing FIG. 12. The RNR element includes a neighbor AP information field corresponding to a first AP, a channel number field in the neighbor AP information field is set to 0, and the first AP is an AP operating on the first link in the AP MLD.

S202: A first station receives the beacon frame on the first link.

Optionally, the first station in this embodiment of the present disclosure is a legacy STA, in other words, the first station supports only a protocol earlier than an extremely high throughput (or 802.11be) protocol. Because the first station cannot identify/understand the first indication information in the beacon frame, the first station does not attempt to initiate association on the first link.

S203: The AP MLD sends a BTM request frame in a broadcast manner on the first link, where the BTM request frame includes second indication information, the second indication information indicates a second non-AP MLD associated with the AP MLD to ignore the BTM request frame, and the BTM request frame is used to request the first station associated with the first AP to perform BSS transition.

S204: The first station receives the BTM request frame on the first link.

Optionally, after sending the beacon frame on the first link, the AP MLD may send the BTM request frame in the broadcast manner on the first link. The broadcast BTM request frame may include the second indication information, and the second indication information indicates the second non-AP MLD associated with the AP MLD to ignore the BTM request frame. Because the first station (the first station is a legacy STA) cannot identify or understand the second indication information in the BTM request frame, the BTM request frame may be used to request the first station associated with the first AP to perform BSS transition. The first AP may be an AP operating on the first link in the AP MLD. Therefore, after receiving the BTM request frame, the first station may perform BSS transition based on an indication of the BTM request frame.

Optionally, the second indication information may be located in a reserved bit of a request mode field of the BTM request frame. For example, a bit reserved in the request mode field is used as an ignore bit, to indicate the second non-AP MLD associated with the AP MLD to ignore the BTM request frame.

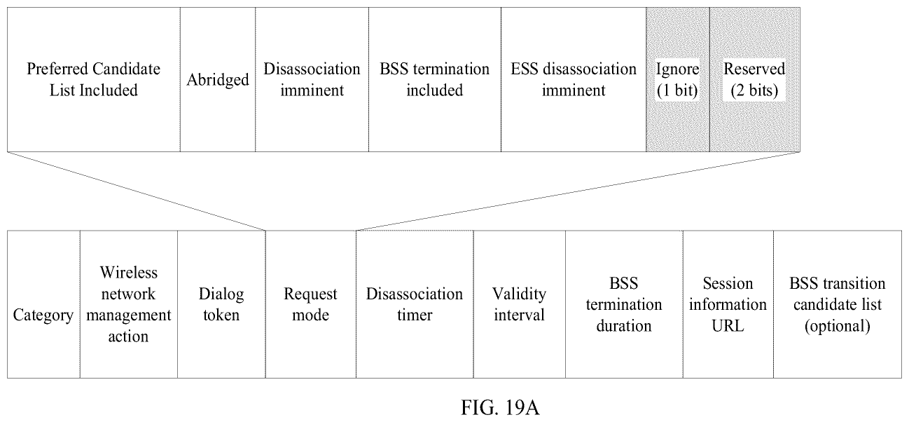

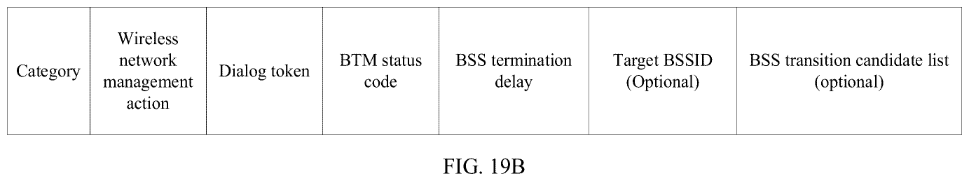

FIG. 19A is a schematic diagram of a frame format of the BTM request frame according to an embodiment of the present disclosure. As shown in FIG. 19A, the BTM request frame includes a category field, a wireless network management action field, a dialog token field, the request mode field, a disassociation timer field, a validity interval field, a BSS termination duration field, a session information uniform resource locator (URL) field, and a BSS transition candidate list field (optional). The request mode field indicates a specific request mode, and includes a preferred candidate list included field, an abridged field, a disassociation imminent field, a BSS termination included field, an extended service set (ESS) disassociation imminent field, an ignore bit (namely, the foregoing second indication information), and a reserved bit. The preferred candidate list included field indicates whether to carry preferred candidate list information. Abridged field: If an associated AP does not recommend or forbids a STA to be switched to a BSS that does not appear in a preferred candidate list, an abridged indicator bit is set to 0. If an associated AP sets a preference value of a BSS that does not appear in a preferred candidate list to 0, an abridged indicator bit is set to 1. When the disassociation imminent field is set to 1, it indicates that an AP sends a disassociation frame to perform disassociation. The BSS termination included field indicates whether a BSS is shut down. The ESS disassociation imminent field indicates whether a STA will be disassociated from an entire ESS.

The ignore bit indicates whether the non-AP MLD that receives the BTM request frame needs to ignore the BTM request frame. For example, when the ignore bit (namely, the foregoing second indication information) is set to 1, it indicates that the non-AP MLD associated with the AP MLD ignores the BTM request frame; and when the ignore bit is set to 0, it indicates that the non-AP MLD associated with the AP MLD cannot ignore the BTM request frame. Certainly, alternatively, when the ignore bit (namely, the foregoing second indication information) is set to 0, it indicates that the non-AP MLD associated with the AP MLD ignores the BTM request frame; and when the ignore bit is set to 1, it indicates that the non-AP MLD associated with the AP MLD cannot ignore the BTM request frame.

FIG. 19B is a schematic diagram of a frame format of a BTM response frame according to an embodiment of the present disclosure. As shown in FIG. 19B, the BTM response frame includes a category field, a wireless network management action field, a dialog token field, a BTM status code field, a BSS termination delay field, a target BSSID field (optional), and a BSS transition candidate list field (optional). The BTM status code field indicates whether a BSS transition request is accepted. The BSS termination delay field indicates duration after a BSS terminates.

To better understand the multi-link communication method in this embodiment of the present disclosure, the following uses an example for description.

For example, it is assumed that the AP MLD has three links: a link 1, a link 2, and a link 3. In the association process, the three links allow a legacy STA to associate with each other. However, the AP MLD wants to use the link 3 as a clean link at a moment, and transfers a legacy STA associated with the link 3 to another link. The link 3 is used for only a low-latency service of a non-AP MLD. The AP MLD sends a beacon frame on the link 3, where a supported rates and BSS membership selectors element included in the beacon frame carries a BSS membership selector whose value is 120, to indicate unassociated non-AP MLDs to initiate multi-link setup through other links (the link 1 and the link 2). The AP MLD sends a broadcast BTM request frame, and sets an ignore bit in the BTM request frame to 1. After receiving the broadcast BTM request frame, the legacy STA on the link 3 needs to perform BSS transition. An associated non-AP MLD ignores the frame.

In this embodiment of the present disclosure, after association succeeds, when the AP MLD wants to use a link as a clean link at a moment, the AP MLD sends, on the link, a beacon frame carrying a supported rates and BSS membership selectors element, and sets a BSS membership selector in the supported rates and BSS membership selectors element to 120. In addition, a BTM request frame is sent on the link, and a reserved bit in the BTM request frame is used to add an indication, indicating an associated non-AP MLD to ignore the frame and an associated legacy STA to perform BSS transition. In this way, a low-latency service on the link is not interfered by a non-low-latency service.

In addition, the AP MLD does not need to separately set up a multicast group for legacy STAs to send a multicast BTM request frame, so that all the legacy STAs perform BSS switching. In other words, the AP MLD does not need to perform unicast BTM request/response frame exchange with each legacy STA, so that all the legacy STAs perform BSS switching. In this way, signaling overheads are reduced, and BSS switching efficiency is high.

### Embodiment 3

Embodiment 3 of the present disclosure may be implemented independently, or may be implemented together with Embodiment 1 or Embodiment 2. This is not limited in the present disclosure. When Embodiment 3 of the present disclosure is implemented together with Embodiment 1, the first frame in Embodiment 1 is an association response frame or a reassociation response frame. When Embodiment 3 of the present disclosure is implemented together with Embodiment 2, Embodiment 3 of the present disclosure may be after step S201 in Embodiment 2, and a second device in Embodiment 3 of the present disclosure is the first non-AP MLD in Embodiment 2.

Optionally, this embodiment of the present disclosure is mainly used in an enhanced link subset mapping scenario. In this scenario, a clean link can be used to transmit only a low-latency service, and how to indicate a TID that can be used by the low-latency service has not been resolved. Therefore, in Embodiment 3 of the present disclosure, TID space (0 to 7) is divided into two parts by using a QoS map element. One part is used for non-low-latency services, and the other part is used for low-latency services, so that the low-latency services and the non-low-latency services can be distinguished by using TIDs. The following describes this embodiment of the present disclosure in detail.

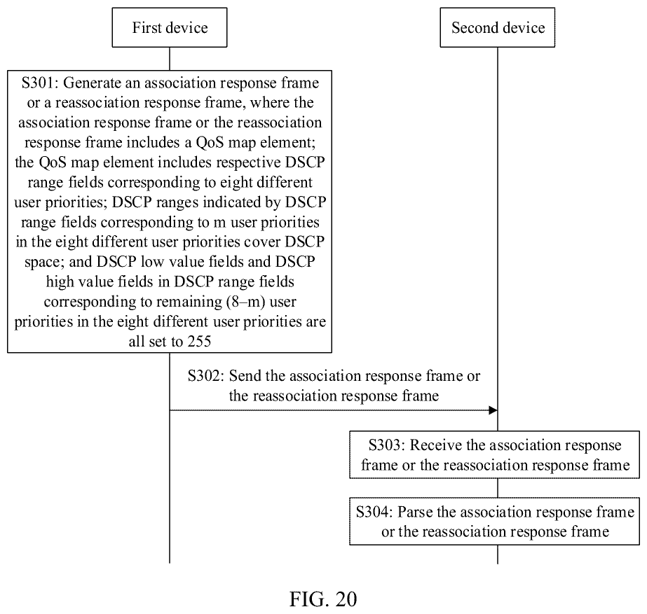

FIG. 20 is a third schematic flowchart of a multi-link communication method according to an embodiment of the present disclosure. The multi-link communication method is mainly used in a multi-link setup process or an association process. As shown in FIG. 20, the multi-link communication method includes but is not limited to the following steps.

S301: A first device generates an association response frame or a reassociation response frame, where the association response frame or the reassociation response frame includes a QoS map element; the QoS map element includes respective DSCP range fields corresponding to eight different user priorities; DSCP ranges indicated by DSCP range fields corresponding to m user priorities in the eight different user priorities cover DSCP space; and DSCP low value fields and DSCP high value fields in DSCP range fields corresponding to remaining (8−m) user priorities in the eight different user priorities are all set to 255.

S302: The first device sends the association response frame or the reassociation response frame.

S303: The second device receives the association response frame or the reassociation response frame.

S304: The second device parses the association response frame or the reassociation response frame.

Optionally, in this embodiment of the present disclosure, the first device is an AP or an AP MLD, and the second device is an EHT STA or a non-AP MLD.

The user priority and the TID are not distinguished in this embodiment of the present disclosure. There is a one-to-one correspondence between the user priority and the TID, and the user priority and the TID may be used alternatively in this embodiment of the present disclosure.

Optionally, the association response frame or the reassociation response frame includes the QoS map element. For a frame format of the QoS map element, refer to the foregoing FIG. 11. The QoS map element may indicate the second device supporting a low-latency service how to perform mapping from a DSCP to a TID/user priority. The QoS map element includes the respective DSCP range fields corresponding to the eight different user priorities (0 to 7). The DSCP ranges indicated by the DSCP range fields corresponding to the m user priorities in the eight different user priorities covers the DSCP space, where the DSCP space is an interval [0, 63]. In other words, a union set of the DSCP ranges indicated by the DSCP range fields corresponding to the m user priorities includes the interval [0, 63]. m is a positive integer less than 8.

The DSCP low value fields and the DSCP high value fields in the DSCP range fields corresponding to remaining (8−m) user priorities in the eight different user priorities are all set to 255. It can be learned from the foregoing descriptions of the QoS map element that when both the DSCP low value fields and the DSCP high value fields are all set to 255, it indicates that the corresponding user priorities are not used. In other words, these TIDs (namely, TIDs respectively corresponding to the (8−m) user priorities) are reserved for low-latency services.

In other words, the first device maps the DSCP space to a subset of the TID space by using the QoS map element, and TIDs in the subset are used for non-low-latency services. In addition, the remaining TIDs in the TID space are used for low-latency services reported by a STA or the non-AP MLD according to an SCS mechanism, or identify an SCS stream added by using an SCS request frame. In an example, DSCP ranges indicated by DSCP range fields corresponding to TIDs 0, 2, 4, and 6 cover the entire DSCP space (0 to 63), in other words, the TIDs 0, 2, 4, and 6 are used for non-low-latency services. In addition, DSCP low value fields and DSCP high value fields in DSCP range fields corresponding to TIDs 1, 3, 5, and 7 are all set to 255, in other words, the TIDs 1, 3, 5, and 7 are used for low-latency services reported by the STA or the non-AP MLD according to the SCS mechanism. In another example, DSCP ranges indicated by DSCP range fields corresponding to TIDs 0, 1, 2, and 3 cover the entire DSCP space (0 to 63), in other words, the TIDs 0, 1, 2, and 3 are used for non-low-latency services. In addition, DSCP low value fields and DSCP high value fields in DSCP range fields corresponding to TIDs 4, 5, 6, and 7 are all set to 255, in other words, the TIDs 4, 5, 6, and 7 are used for low-latency services reported by the STA or the non-AP MLD according to the SCS mechanism.

In other words, DSCP ranges indicated by DSCP range fields corresponding to all TIDs in a first TID set in the QoS map element cover the entire DSCP space, namely, the interval [0, 63]; and DSCP low value fields and DSCP high value fields in DSCP range fields corresponding to all TIDs in a second TID set are all set to 255. The first TID set includes one or more TIDs, and the second TID set includes one or more TIDs. A union set of the first TID set and the second TID set is TID space, in other words, 0, 1, 2, 3, 4, 5, 6, and 7. The TIDs in the first TID set are used to identify non-low-latency services, and the TIDs in the second TID set are used to identify low-latency services, or only the AP MLD is allowed to map the SCS stream successfully added according to the SCS mechanism to the second TID set. In other words, the TID space (0 to 7) is divided into two parts by using the QoS map element. One part is used for non-low-latency services, and the other part is used for low-latency services. In addition, the QoS Map element is used to configure which TIDs are used for the low-latency services and which TIDs are used for the non-low-latency services.

Optionally, the first device sends the association response frame or the reassociation response frame carrying the QoS map element, to notify the second device which TIDs are used for the low-latency services and which TIDs are used for the non-low-latency services. Therefore, when reporting a low-latency traffic stream according to the SCS mechanism, the second device may select an expected TID from TIDs used by a low-latency service, and notify the first device of the expected TID. Then, the first device finally determines a TID (which may be different from the expected TID) and an AC to which the low-latency traffic stream reported by the second device is mapped. For example, a low-latency service is mapped to an AC_VO, or an AC_LL (low-latency) is newly defined. In this case, more than two TIDs may be mapped to an AC. When the AC_VO or the newly defined AC_LL obtains channel access, data with a higher priority is preferentially sent based on a user priority. Low-latency data with different TIDs has a separate sending queue. In this way, channel access fairness can be ensured. For example, for a same low-latency service, an AC expected by a STA 1 is background, an AC expected by a STA 2 is voice, and the STA 1 and the STA 2 belong to a same BSS. If an AP does not map the low-latency service to a same AC, channel access is unfair for the STA 1 and the STA 2 (this is because a channel access priority of the AC_VO is higher than that of an AC_BK).

Optionally, after the second device supporting the low-latency service successfully adds a low-latency traffic stream according to the SCS mechanism, both the first device and the second device need to map data of the low-latency traffic stream to a TID and an AC that are determined according to the SCS mechanism. It may be understood that in this embodiment of the present disclosure, some TIDs in the TID space (0 to 7) are allocated to the low-latency services for use by using the QoS map element, and the other TIDs are allocated to the non-low-latency services for use by using the QoS map element. However, the first device and the second device may still specifically negotiate, according to the SCS mechanism, a TID to which a low-latency traffic stream is mapped, and use the TID negotiated according to the SCS mechanism for identification when subsequently transmitting data of the low-latency traffic stream.

In this embodiment of the present disclosure, the TID space (0 to 7) is divided into the two parts by using the QoS map element. One part is used for the non-low-latency services, and the other part is used for the low-latency services. Whether a corresponding MPDU is low-latency service data or non-low-latency service data may be distinguished by using a TID, in other words, a low-latency service and a non-low-latency service are not mapped to a same TID. In addition, this embodiment of the present disclosure may further support implementation of an enhanced link subset mapping scheme, so that the clean link can be used to transmit only the low-latency service.

### Embodiment 4

Embodiment 4 of the present disclosure may be implemented independently, or may be implemented together with any one or more of Embodiments 1 to 3. This is not limited in the present disclosure.

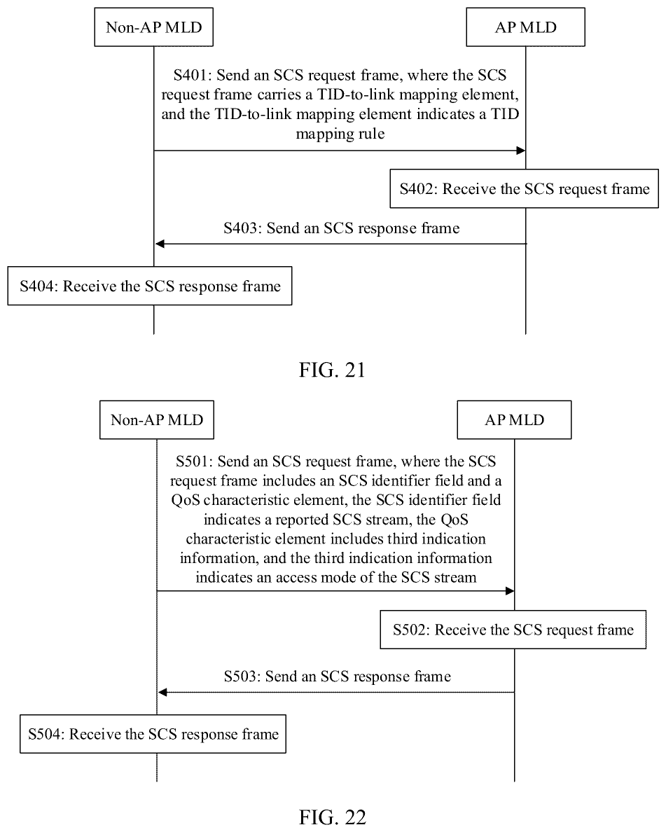

FIG. 21 is a fourth schematic flowchart of a multi-link communication method according to an embodiment of the present disclosure. The multi-link communication method is mainly used in an SCS mechanism. As shown in FIG. 21, the multi-link communication method includes but is not limited to the following steps.

S401: A non-AP MLD sends an SCS request frame, where the SCS request frame carries a TID-to-link mapping element, and the TID-to-link mapping element indicates a TID mapping rule.

S402: An AP MLD receives the SCS request frame.

S403: The AP MLD sends an SCS response frame.

S404: The non-AP MLD receives the SCS response frame.

Optionally, the non-AP MLD generates and sends the SCS request frame, where the SCS request frame includes one or more SCSID fields. One SCS identifier field indicates one reported SCS stream. For a frame format of the SCS request frame, refer to the foregoing descriptions, for example, shown in FIG. 6 to FIG. 8. The SCS request frame may carry the TID-to-link mapping element, and the TID-to-link mapping element indicates the TID mapping rule. In other words, the non-AP MLD may send an expected TID-to-link mapping rule to the AP MLD by sending the SCS request frame carrying the TID-to-link mapping element. A TID-to-link mapping rule finally determined by the AP MLD may be the same as or different from the TID-to-link mapping rule expected by the non-AP MLD.

After receiving the SCS request frame, the AP MLD may reply with the SCS response frame. The SCS response frame includes a status code field, and the status code field indicates whether the AP MLD accepts an SCS stream reported by using the SCS request frame. Specifically, when the status code field indicates that the AP MLD accepts the SCS stream, the SCS response frame further carries a TID-to-link mapping element indicating a TID mapping rule. In other words, when the AP MLD accepts the SCS stream, it also indicates that the AP MLD accepts TID-to-link mapping negotiation initiated by the non-AP MLD. If content of the TID-to-link mapping element carried in the SCS response frame is exactly the same as that of the TID-to-link mapping element carried in the SCS request frame, it indicates that the AP MLD agrees with the TID mapping rule indicated by the TID-to-link mapping element carried in the SCS request frame. If content of the TID-to-link mapping element carried in the SCS response frame is different from content of the TID-to-link mapping element carried in the SCS request frame, it indicates that the AP MLD does not agree with the TID mapping rule indicated by the TID-to-link mapping element carried in the SCS request frame, and the TID mapping rule recommended by the AP MLD is carried in the TID-to-link mapping element of the SCS response frame.

When the status code field indicates that the AP MLD rejects the SCS stream, the SCS response frame does not carry the TID-to-link mapping element. In other words, when the AP MLD rejects the SCS stream, it also indicates that the AP MLD rejects TID-to-link mapping negotiation initiated by the non-AP MLD.

Optionally, when this embodiment of the present disclosure is implemented together with Embodiment 3, in Embodiment 3, the non-AP MLD is notified, by using the QoS map element, which TIDs are used for low-latency services and which TIDs are used for non-low-latency services. In this embodiment of the present disclosure, TID-to-link mapping negotiation is performed according to the SCS mechanism. Therefore, in a data transmission process, a transmit end (the AP MLD or the non-AP MLD) sends a data packet. A TID of the data packet is set based on the QoS map element in Embodiment 3 when the data packet does not match the SCS stream (whether the data packet matches the SCS stream may be identified based on the TCLAS element described above), or a TID of the data packet is set based on the TID-to-link mapping element carried in the SCS response frame when the data packet matches the SCS stream. In other words, when a frame sent by the transmit end (the AP MLD or the non-AP MLD) can match an SCS stream (whether the frame matches the SCS stream is specifically identified based on the TCLAS element), the transmit end should perform mapping based on a user priority/TID in a TSPEC element or the TCLAS element, in other words, perform mapping based on a TID negotiated in the SCS mechanism, instead of performing mapping based on a user priority/TID calculated according to a TID mapping rule in the QoS map element. Only when the frame does not match any SCS stream, the frame is mapped to the corresponding user priority/TID according to the TID mapping rule in the QoS map element.

In this embodiment of the present disclosure, TID-to-link mapping negotiation is performed during SCS negotiation. This can reduce signaling overheads and improve accuracy. When TID-to-link mapping negotiation is performed in an association process, a low-latency service may not occur in the association process. Therefore, TID-to-link mapping is inaccurate. When TID-to-link mapping negotiation is performed in the SCS mechanism, a STA uses the SCS mechanism to negotiate which TIDs are used by low-latency services when the STA discovers the low-latency services. Therefore, TID-to-link mapping is more accurate.

In an optional embodiment, when the non-AP MLD does not carry the TID-to-link mapping element in the SCS request frame, the AP MLD may still carry the TID-to-link mapping element in the SCS response frame to indicate the non-AP MLD to transmit data according to the TID mapping rule indicated by the TID-to-link mapping element. Specifically, the non-AP MLD sends the SCS request frame, where the SCS request frame includes the SCS identifier field, and the SCS identifier field indicates the reported SCS stream. After receiving the SCS request frame, the AP MLD replies with the SCS response frame. The SCS response frame includes the status code field. The status code field is set to a first value (for example, 0), to indicate that the AP MLD accepts the SCS stream. The SCS response frame further carries the TID-to-link mapping element, and the TID-to-link mapping element indicates the TID mapping rule. The SCS response frame indicates the non-AP MLD to transmit the data according to the TID mapping rule indicated by the TID-to-link mapping element.

In this embodiment of the present disclosure, the SCS response frame directly carries the TID-to-link mapping element, to indicate the non-AP MLD to transmit the data according to the TID mapping rule indicated by the TID-to-link mapping element. This can reduce signaling overheads.

### Embodiment 5

Embodiment 5 of the present disclosure may be implemented independently, or may be implemented together with any one or more of Embodiments 1 to 4. This is not limited in the present disclosure.

FIG. 22 is a fifth schematic flowchart of a multi-link communication method according to an embodiment of the present disclosure. The multi-link communication method is mainly used in an SCS mechanism. As shown in FIG. 22, the multi-link communication method includes but is not limited to the following steps.

S501: A non-AP MLD sends an SCS request frame, where the SCS request frame includes an SCS identifier field and a QoS characteristic element, the SCS identifier field indicates a reported SCS stream, the QoS characteristic element includes third indication information, and the third indication information indicates an access mode of the SCS stream.

S502: An AP MLD receives the SCS request frame.

S503: The AP MLD sends an SCS response frame.

S504: The non-AP MLD receives the SCS response frame.

Optionally, the non-AP MLD generates and sends the SCS request frame, where the SCS request frame includes the SCSID field and the QOS characteristic element. The SCS identifier field indicates the reported SCS stream. For a frame format of the SCS request frame, refer to the foregoing descriptions, for example, shown in FIG. 6, FIG. 7B, and FIG. 8. The QoS characteristic element may include the third indication information, and the third indication information may indicate the access mode of the SCS stream.

Optionally, the third indication information may be located in a control information field of the QoS characteristic element. The third indication information may be a newly added field in the control information field, for example, an access policy field. Certainly, the third indication information may alternatively have another name. This is not limited in embodiments of the present disclosure.

Optionally, the QOS characteristic element may further include fourth indication information, and the fourth indication information indicates an access category (AC) to which a data packet of the SCS stream is mapped. The fourth indication information may also be located in the control information field of the QoS characteristic element. A length of the fourth indication information is 2 bits, and the fourth indication information may be a newly added field in the control information field, for example, an access category index (AC_index) field. Certainly, the fourth indication information may alternatively have another name. This is not limited in embodiments of the present disclosure.

Optionally, the QOS characteristic element may further include fifth indication information, and the fifth indication information indicates a restricted target wake time (rTWT) preference for transmitting the data packet of the SCS stream. In other words, whether a STA requests an AP to set up an rTWT for transmitting the SCS stream. The fifth indication information may also be located in the control information field of the QoS characteristic element. The fifth indication information may be a newly added field in the control information field, for example, an rTWT preference field. Certainly, the fifth indication information may alternatively have another name. This is not limited in embodiments of the present disclosure. For example, it is assumed that when the fifth indication information is 2 bits, it indicates that the AP is not requested to set up the rTWT when the rTWT preference field is set to 00, it indicates that the AP is requested to set up the rTWT when the rTWT preference field is set to 01, it indicates that a trigger-enabled rTWT is requested to be set up when the rTWT preference field is set to 10, or 11 is a reserved value when the rTWT preference field is set to 11.

It is assumed that when the fifth indication information is 1 bit, it indicates that the AP is requested to set up a TWT for transmitting the SCS stream when the rTWT preference is set to 1. Otherwise, the rTWT preference is set to 0.

It should be understood that one bit in a target wake time (TWT) element indicates whether the TWT is trigger-enabled. When the bit is set to 1, the STA can wait for only active trigger of the AP and cannot perform EDCA. When the bit is set to 0, the STA is allowed to perform EDCA.

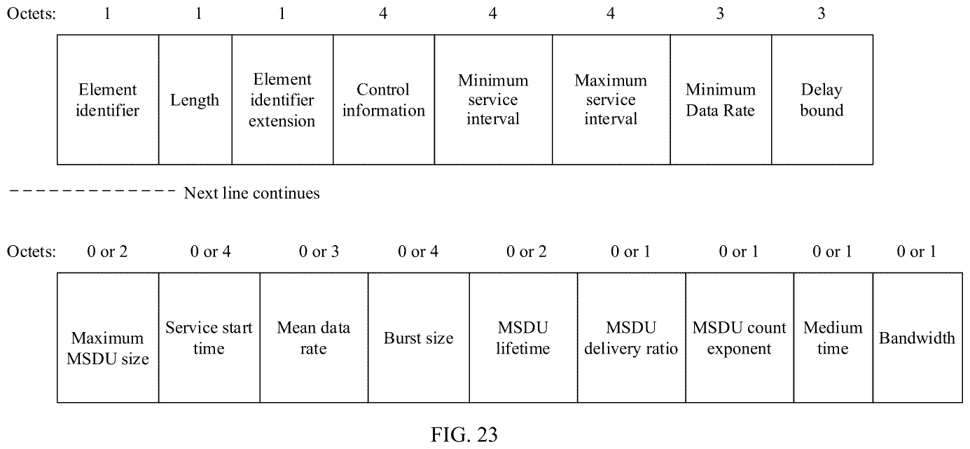

FIG. 23 is a schematic diagram of a frame format of the QoS characteristic element according to an embodiment of the present disclosure. As shown in FIG. 23, the QoS characteristic element includes but is not limited to the control information field. FIG. 24 is a schematic diagram of a frame format of the control information field according to an embodiment of the present disclosure. As shown in FIG. 24, the control information field includes a direction field, a traffic identifier (TID) field, a user priority field, a presence bitmap of additional parameters field, and the access policy field (namely, the third indication information). Optionally, the control information field further includes the AC_index field (namely, the fourth indication information), the rTWT preference field (namely, the fifth indication information), and/or a reserved bit. When the direction field is set to 00, it indicates an uplink. When the direction field is set to 10, it indicates a downlink. When the direction field is set to 01, it indicates a P2P direct link. When the direction field is set to 11, it indicates a reserved value. A value of the TID field ranges from 0 to 7, and 8 to 15 are reserved values. A value of the user priority field also ranges from 0 to 7, and the user priority field is set to a value same as that of the TID field. The 2-bit AC_index field (namely, the fourth indication information) indicates an AC to which the data packet of the SCS stream is mapped. The rTWT preference field (namely, the fifth indication information) indicates whether the STA requests the AP to set up the rTWT for transmitting the SCS stream.

For uplink transmission, the access policy field (namely, the third indication information) may indicate that the access mode of the SCS stream is one or more of the following: EDCA only, scheduling only (including Trigger and TXS), or a combination of EDCA and scheduling. In other words, when the direction field in the control information field is set to 00, an access policy may be EDCA only, scheduling only, or the combination of EDCA and scheduling.

For downlink transmission, the access policy field (namely, the third indication information) may indicate that the access mode of the SCS stream is one or more of the following: EDCA only and rTWT. In other words, when the direction field in the control information field is set to 10, an access policy may be EDCA only, rTWT, or the combination of EDCA and rTWT.

For P2P transmission, the access policy field (namely, the third indication information) may indicate that the access mode of the SCS stream is one or more of the following: EDCA only and scheduling only (namely, TXS). In other words, when the direction field in the control information field is set to 01, an access policy may be EDCA only, scheduling only (namely, TXS), or the combination of EDCA and scheduling.

Optionally, after receiving the SCS request frame, the AP MLD may reply with the SCS response frame. The SCS response frame includes a status code field, and the status code field indicates whether the AP MLD accepts the SCS stream reported by using the SCS request frame. In an implementation, when the status code field indicates that the AP MLD accepts the SCS stream, content of a QoS characteristic element included in the SCS response frame may be the same as content of the QoS characteristic element included in the SCS request frame. When the status code field indicates that the AP MLD rejects the SCS stream, content of a QoS characteristic element included in the SCS response frame may be different from content of the QOS characteristic element included in the SCS request frame.

It should be understood that when this embodiment of the present disclosure is implemented together with Embodiment 4, a frame format of an SCS descriptor element in the SCS request frame in Embodiment 4 should be the frame format shown in FIG. 7B.

In this embodiment of the present disclosure, a new field, for example, the access policy field, is added to the control info field of the QoS characteristic element, to indicate the access mode requested by the STA. Another new field, for example, the AC_index (2 bits) field, is added to the control info field to indicate the AC the corresponding data packet is mapped to. The SCS mechanism may indicate an access policy of a corresponding traffic stream and an AC to which the traffic stream is mapped. This reduces signaling overheads.

The foregoing content describes in detail the methods provided in the present disclosure. To facilitate implementation of the foregoing solutions in embodiments of the present disclosure, embodiments of the present disclosure further provide corresponding apparatuses or devices.

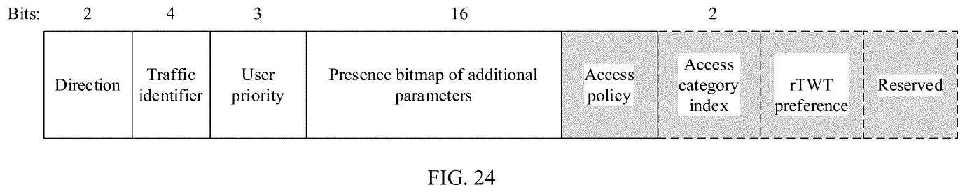

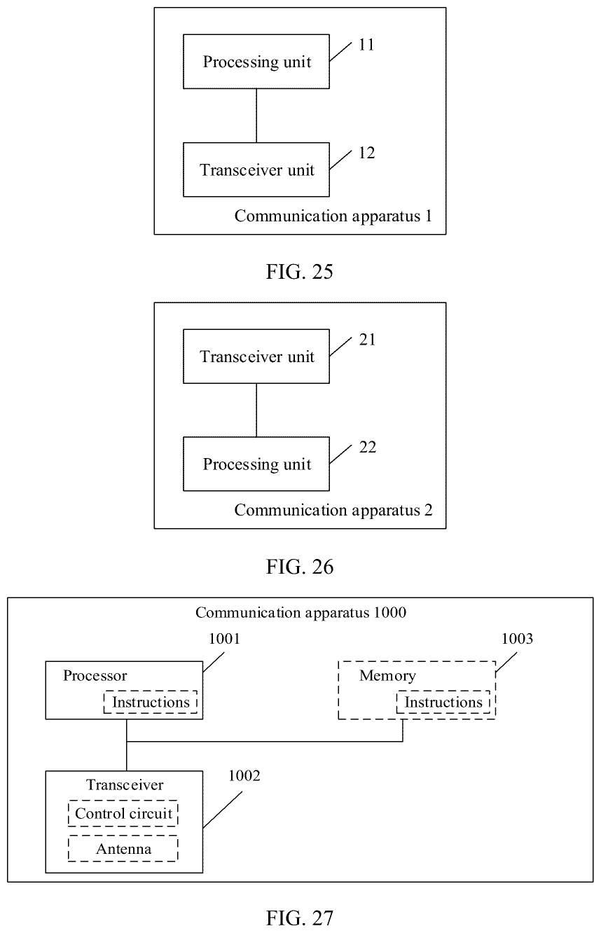

In embodiments of the present disclosure, the AP MLD, the first device, the non-AP MLD, the first station, the second device, or the like may be divided into functional modules based on the foregoing method examples. For example, each functional module may be obtained through division for each corresponding function, or two or more functions may be integrated into one processing module. The integrated module may be implemented in a form of hardware, or may be implemented in a form of a software functional module. It should be noted that, in embodiments of the present disclosure, division into modules is an example, and is merely logical function division. In actual implementation, another division manner may be used. Communication apparatuses in embodiments of the present disclosure are described below in detail with reference to FIG. 25 to FIG. 27. The communication apparatus is any one of an AP MLD, a first device, a non-AP MLD, a first station, or a second device. Further, the communication apparatus may be an apparatus in any one of an AP MLD, a first device, a non-AP MLD, a first station, or a second device.

When an integrated unit is used, refer to FIG. 25. FIG. 25 is a schematic diagram of a structure of a communication apparatus 1 according to an embodiment of the present disclosure. The communication apparatus 1 may be any one of an AP MLD or a first device, or may be a chip in an AP MLD or a first device, for example, a Wi-Fi chip. As shown in FIG. 25, the communication apparatus includes a processing unit 11 and a transceiver unit 12.

In a design, the processing unit 11 is configured to generate a first frame, where the first frame includes a supported rates and BSS membership selectors element, the supported rates and BSS membership selectors element includes first indication information, and the first indication information indicates that a non-access point multi-link device non-AP MLD is disallowed to initiate multi-link setup with the AP MLD on a first link. The transceiver unit 12 is configured to send the first frame on the first link.

Optionally, the AP MLD has at least two links, and the at least two links include the first link and a second link. The transceiver unit 12 is further configured to send a beacon frame or a probe response frame on the second link, where the beacon frame or the probe response frame includes a reduced neighbor report RNR element, the RNR element includes a neighbor AP information field corresponding to a first AP, a channel number field in the neighbor AP information field is set to 0, and the first AP is an AP operating on the first link in the AP MLD.

Optionally, the first indication information further indicates that a single-link station supporting an extremely high throughput protocol is disallowed to set up association with the AP MLD on the first link.

Optionally, the first indication information is that a BSS membership selector in the supported rates and BSS membership selectors element is set to a preset value. The preset value is 120 or 121.

Optionally, the first frame is any one of the following: a beacon frame, a probe response frame, an association response frame, or a reassociation response frame.

Optionally, when the first frame is the association response frame or the reassociation response frame, the first frame further includes a quality of service QoS map element, where the QoS map element includes respective DSCP range fields corresponding to eight different user priorities; DSCP ranges indicated by DSCP range fields corresponding to m user priorities in the eight different user priorities cover DSCP space, where the DSCP space is an interval [0, 63]; and DSCP low value fields and DSCP high value fields in DSCP range fields corresponding to remaining (8−m) user priorities in the eight different user priorities are all set to 255. m is a positive integer less than 8.

Optionally, the transceiver unit 12 is further configured to: receive a stream classification service SCS request frame, where the SCS request frame includes an SCS identifier field, and the SCS identifier field indicates a reported SCS stream; and send an SCS response frame, where the SCS response frame includes a status code field, and the status code field indicates whether the AP MLD accepts the SCS stream.

Optionally, when the status code field indicates that the AP MLD accepts the SCS stream, the SCS response frame further includes a TID-to-link mapping element, and the TID-to-link mapping element indicates a TID mapping rule.

Optionally, the transceiver unit 12 is further configured to send a data packet, where a TID of the data packet is set based on the QoS map element when the data packet does not match the SCS stream, or a TID of the data packet is set based on the TID-to-link mapping element carried in the SCS response frame when the data packet matches the SCS stream.

It should be understood that, the communication apparatus in this design may correspondingly perform Embodiment 1, and the foregoing operations or functions performed by the units in the communication apparatus are respectively used to implement corresponding operations performed by the AP MLD in Embodiment 1. For brevity, details are not described herein again.

In a design, the transceiver unit 12 is configured to send a beacon frame on a first link, where the beacon frame includes a supported rates and BSS membership selectors element, the supported rates and BSS membership selectors element includes first indication information, and the first indication information indicates that a first non-AP MLD is disallowed to initiate multi-link setup with the AP MLD on the first link. The transceiver unit 12 is further configured to send a BTM request frame on the first link, where the BTM request frame includes second indication information, the second indication information indicates a second non-AP MLD associated with the AP MLD to ignore the BTM request frame, and the BTM request frame is used to request a first station associated with a first AP to perform BSS transition. The first AP is an AP operating on the first link in the AP MLD, and the first station supports only a protocol earlier than an extremely high throughput protocol.

Optionally, the processing unit 11 is configured to generate the beacon frame and the BTM request frame.

Optionally, the second indication information is located in a reserved bit of a request mode field in the BTM request frame.

Optionally, the first indication information further indicates that a single-link station supporting an extremely high throughput protocol is disallowed to set up association with the AP MLD on the first link.

Optionally, the first indication information is that a BSS membership selector in the supported rates and BSS membership selectors element is set to a preset value. The preset value is 120 or 121.

Optionally, the AP MLD is disallowed to reply with a probe response frame and/or an association response frame on the first link.

Optionally, the transceiver unit 12 is further configured to send a beacon frame or a probe response frame on a second link, where the beacon frame or the probe response frame includes a reduced neighbor report RNR element, the RNR element includes a neighbor AP information field corresponding to the first AP, a channel number field in the neighbor AP information field is set to 0, and the first AP is an AP operating on the first link in the AP MLD.

It should be understood that, the communication apparatus in this design may correspondingly perform Embodiment 2, and the foregoing operations or functions performed by the units in the communication apparatus are respectively used to implement corresponding operations performed by the AP MLD in Embodiment 2. For brevity, details are not described herein again.

In a design, the processing unit 11 is configured to generate an association response frame or a reassociation response frame, where the association response frame or the reassociation response frame includes a QoS map element; the QoS map element includes respective DSCP range fields corresponding to eight different user priorities; DSCP ranges indicated by DSCP range fields corresponding to m user priorities in the eight different user priorities cover DSCP space, where the DSCP space is an interval [0, 63]; and DSCP low value fields and DSCP high value fields in DSCP range fields corresponding to remaining (8−m) user priorities in the eight different user priorities are all set to 255. The transceiver unit 12 is configured to send the association response frame or the reassociation response frame, where m is a positive integer less than 8.

It should be understood that, the communication apparatus in this design may correspondingly perform Embodiment 3, and the foregoing operations or functions performed by the units in the communication apparatus are respectively used to implement corresponding operations performed by the first device in Embodiment 3. For brevity, details are not described herein again.

In a design, the transceiver unit 12 is configured to receive an SCS request frame, where the SCS request frame carries a TID-to-link mapping element, and the TID-to-link mapping element indicates a TID mapping rule. The transceiver unit 12 is further configured to send an SCS response frame.

Optionally, the processing unit 11 is configured to generate the SCS response frame.

Optionally, the SCS request frame includes an SCSID field, and the SCS identifier field indicates a reported SCS stream. The SCS response frame includes a status code field, and the status code field indicates whether the AP MLD accepts the SCS stream reported by using the SCS request frame. When the status code field indicates that the AP MLD accepts the SCS stream, the SCS response frame further carries a TID-to-link mapping element indicating a TID mapping rule. When the status code field indicates that the AP MLD rejects the SCS stream, the SCS response frame does not carry the TID-to-link mapping element.

It should be understood that, the communication apparatus in this design may correspondingly perform Embodiment 4, and the foregoing operations or functions performed by the units in the communication apparatus are respectively used to implement corresponding operations performed by the AP MLD in Embodiment 4. For brevity, details are not described herein again.

In a design, the transceiver unit 12 is configured to receive an SCS request frame, where the SCS request frame includes an SCS identifier field and a QoS characteristic element, the SCS identifier field indicates a reported SCS stream, the QoS characteristic element includes third indication information, and the third indication information indicates an access mode of the SCS stream. The transceiver unit 12 is further configured to send an SCS response frame.

Optionally, the processing unit 11 is configured to generate the SCS response frame.

Optionally, the QoS characteristic element may further include fourth indication information, and the fourth indication information indicates an access category to which a data packet of the SCS stream is mapped.

Optionally, both the third indication information and the fourth indication information are located in a control information field of the QoS characteristic element.

It should be understood that, the communication apparatus in this design may correspondingly perform Embodiment 5, and the foregoing operations or functions performed by the units in the communication apparatus are respectively used to implement corresponding operations performed by the AP MLD in Embodiment 5. For brevity, details are not described herein again.

FIG. 26 is a schematic diagram of a structure of a communication apparatus 2 according to an embodiment of the present disclosure. The communication apparatus 2 may be any one of a non-AP MLD, a first station, or a second device, or may be a chip in a non-AP MLD, a first station, or a second device, for example, a Wi-Fi chip. As shown in FIG. 26, the communication apparatus includes a transceiver unit 21 and a processing unit 22.

In a design, the transceiver unit 21 is configured to receive a first frame on a first link. The processing unit 22 is configured to parse the first frame, where the first frame includes a supported rates and BSS membership selectors element, the supported rates and BSS membership selectors element includes first indication information, and the first indication information indicates that the non-AP MLD is disallowed to initiate multi-link setup with an AP MLD on the first link.

Optionally, the transceiver unit 21 is further configured to receive a beacon frame or a probe response frame on a second link, where the beacon frame or the probe response frame includes a reduced neighbor report RNR element, the RNR element includes a neighbor AP information field corresponding to a first AP, a channel number field in the neighbor AP information field is set to 0, and the first AP is an AP operating on the first link in the AP MLD.

Optionally, the first indication information further indicates that a single-link station supporting an extremely high throughput protocol is disallowed to set up association with the AP MLD on the first link.

Optionally, the first indication information is that a BSS membership selector in the supported rates and BSS membership selectors element is set to a preset value. The preset value is 120 or 121.

Optionally, the first frame is any one of the following: a beacon frame, a probe response frame, an association response frame, or a reassociation response frame.

Optionally, when the first frame is the association response frame or the reassociation response frame, first frame further includes a quality of service QoS map element, where the QoS map element includes respective DSCP range fields corresponding to eight different user priorities; DSCP ranges indicated by DSCP range fields corresponding to m user priorities in the eight different user priorities cover DSCP space, where the DSCP space is an interval [0, 63], and m is a positive integer less than 8; and DSCP low value fields and DSCP high value fields in DSCP range fields corresponding to remaining (8−m) user priorities in the eight different user priorities are all set to 255.

Optionally, the transceiver unit 21 is further configured to: send a stream classification service SCS request frame, where the SCS request frame includes an SCS identifier field, and the SCS identifier field indicates a reported SCS stream; and receive an SCS response frame, where the SCS response frame includes a status code field, and the status code field indicates whether the AP MLD accepts the SCS stream.

Optionally, when the status code field indicates that the AP MLD accepts the SCS stream, the SCS response frame further includes a TID-to-link mapping element, and the TID-to-link mapping element indicates a TID mapping rule.

Optionally, the transceiver unit 21 is further configured to send a data packet, where a TID of the data packet is set based on the QoS map element when the data packet does not match the SCS stream, or a TID of the data packet is set based on the TID-to-link mapping element carried in the SCS response frame when the data packet matches the SCS stream.

It should be understood that, the communication apparatus in this design may correspondingly perform Embodiment 1, and the foregoing operations or functions performed by the units in the communication apparatus are respectively used to implement corresponding operations performed by the non-AP MLD in Embodiment 1. For brevity, details are not described herein again.

In a design, the transceiver unit 21 is configured to receive a beacon frame on a first link, where the beacon frame includes a supported rates and BSS membership selectors element, the supported rates and BSS membership selectors element includes first indication information, and the first indication information indicates that a first non-AP MLD is disallowed to initiate multi-link setup with an AP MLD on the first link. The transceiver unit 21 is further configured to receive a BTM request frame on the first link, where the BTM request frame includes second indication information, the second indication information indicates a second non-AP MLD associated with the AP MLD to ignore the BTM request frame, and the BTM request frame is used to request a first station associated with a first AP to perform BSS transition. The first AP is an AP operating on the first link in the AP MLD, and the first station supports only a protocol earlier than an extremely high throughput protocol.

Optionally, the processing unit 22 is configured to parse the beacon frame and the BTM request frame.

Optionally, the second indication information is located in a reserved bit of a request mode field in the BTM request frame.

Optionally, the first indication information further indicates that a single-link station supporting an extremely high throughput protocol is disallowed to set up association with the AP MLD on the first link.

Optionally, the first indication information is that a BSS membership selector in the supported rates and BSS membership selectors element is set to a preset value. The preset value is 120 or 121.

It should be understood that, the communication apparatus in this design may correspondingly perform Embodiment 2, and the foregoing operations or functions performed by the units in the communication apparatus are respectively used to implement corresponding operations performed by the first station in Embodiment 2. For brevity, details are not described herein again.

In a design, the transceiver unit 21 is configured to receive an association response frame or a reassociation response frame. The processing unit 22 is configured to parse the association response frame or the reassociation response frame, where the association response frame or the reassociation response frame includes a QoS map element; the QoS map element includes respective DSCP range fields corresponding to eight different user priorities; DSCP ranges indicated by DSCP range fields corresponding to m user priorities in the eight different user priorities cover DSCP space, where the DSCP space is an interval [0, 63], and m is a positive integer less than 8; and DSCP low value fields and DSCP high value fields in DSCP range fields corresponding to remaining (8−m) user priorities in the eight different user priorities are all set to 255.

It should be understood that, the communication apparatus in this design may correspondingly perform Embodiment 3, and the foregoing operations or functions performed by the units in the communication apparatus are respectively used to implement corresponding operations performed by the second device in Embodiment 3. For brevity, details are not described herein again.

In a design, the transceiver unit 21 is configured to send an SCS request frame, where the SCS request frame carries a TID-to-link mapping element, and the TID-to-link mapping element indicates a TID mapping rule. The transceiver unit 21 is further configured to receive an SCS response frame.

Optionally, the processing unit 22 is configured to parse the SCS response frame.

Optionally, the SCS request frame includes an SCSID field, and the SCS identifier field indicates a reported SCS stream. The SCS response frame includes a status code field, and the status code field indicates whether an AP MLD accepts the SCS stream reported by using the SCS request frame. When the status code field indicates that the AP MLD accepts the SCS stream, the SCS response frame further carries a TID-to-link mapping element indicating a TID mapping rule. When the status code field indicates that the AP MLD rejects the SCS stream, the SCS response frame does not carry the TID-to-link mapping element.

It should be understood that, the communication apparatus in this design may correspondingly perform Embodiment 4, and the foregoing operations or functions performed by the units in the communication apparatus are respectively used to implement corresponding operations performed by the non-AP MLD in Embodiment 4. For brevity, details are not described herein again.

In a design, the transceiver unit 21 is configured to send an SCS request frame, where the SCS request frame includes an SCS identifier field and a QoS characteristic element, the SCS identifier field indicates a reported SCS stream, the QoS characteristic element includes third indication information, and the third indication information indicates an access mode of the SCS stream. The transceiver unit 21 is further configured to receive an SCS response frame.

Optionally, the processing unit 22 is configured to parse the SCS response frame.

Optionally, the QOS characteristic element may further include fourth indication information, and the fourth indication information indicates an access category to which a data packet of the SCS stream is mapped.

Optionally, both the third indication information and the fourth indication information are located in a control information field of the QoS characteristic element.

It should be understood that, the communication apparatus in this design may correspondingly perform Embodiment 5, and the foregoing operations or functions performed by the units in the communication apparatus are respectively used to implement corresponding operations performed by the non-AP MLD in Embodiment 5. For brevity, details are not described herein again.

The foregoing describes the devices in embodiments of the present disclosure, and the following describes possible product forms of these devices. It should be understood that a product in any form that has a function of the AP MLD or the first device in FIG. 25, and a product in any form that has a function of the non-AP MLD, the first station, or the second device in FIG. 26, both fall within the protection scope of embodiments of the present disclosure. It should be further understood that the following descriptions are merely examples, and product forms of the devices in embodiments of the present disclosure are not limited thereto.

In a possible product form, the AP MLD, the first device, the non-AP MLD, the first station, and the second device in embodiments of the present disclosure may be implemented by using a general bus architecture.

For ease of description, refer to FIG. 27. FIG. 27 is a schematic diagram of a structure of a communication apparatus 1000 according to an embodiment of the present disclosure. The communication apparatus 1000 may be a first device or a second device, or may be a chip in a first device or a second device. FIG. 27 shows only main components of the communication apparatus 1000. In addition to a processor 1001 and a transceiver 1002, the communication apparatus may further include a memory 1003 and an input/output apparatus (which is not shown in the figure).

The processor 1001 is mainly configured to: process a communication protocol and communication data, control the entire communication apparatus, execute a software program, and process data of the software program. The memory 1003 is mainly configured to store the software program and the data. The transceiver 1002 may include a control circuit and an antenna. The control circuit is mainly configured to perform conversion between a baseband signal and a radio frequency signal and process the radio frequency signal. The antenna is mainly configured to receive/send a radio frequency signal in a form of an electromagnetic wave. The input/output apparatus, for example, a touchscreen, a display, or a keyboard, is mainly configured to: receive data input by a user and output data to the user.

After the communication apparatus is powered on, the processor 1001 may read the software program in the memory 1003, interpret and execute instructions of the software program, and process the data of the software program. When data needs to be sent wirelessly, the processor 1001 performs baseband processing on the to-be-sent data, and then outputs a baseband signal to a radio frequency circuit. The radio frequency circuit performs radio frequency processing on the baseband signal, and then sends a radio frequency signal in the form of an electromagnetic wave through the antenna. When data is sent to the communication apparatus, the radio frequency circuit receives a radio frequency signal through the antenna, converts the radio frequency signal into a baseband signal, and outputs the baseband signal to the processor 1001. The processor 1001 converts the baseband signal into data, and processes the data.

In another implementation, the radio frequency circuit and the antenna may be disposed independent of the processor that performs baseband processing. For example, in a distributed scenario, the radio frequency circuit and the antenna may be separately disposed independent of the communication apparatus.

The processor 1001, the transceiver 1002, and the memory 1003 may be connected through a communication bus.

In a design, the communication apparatus 1000 may be configured to perform functions of the AP MLD in Embodiment 1. The processor 1001 may be configured to perform step S101 in FIG. 15, and/or another process of the technology described in this specification. The transceiver 1002 may be configured to perform step S102 in FIG. 15, and/or another process of the technology described in this specification.

In another design, the communication apparatus 1000 may be configured to perform functions of the non-AP MLD in Embodiment 1. The processor 1001 may be configured to perform step S104 in FIG. 15, and/or another process of the technology described in this specification. The transceiver 1002 may be configured to perform step S103 in FIG. 15, and/or another process of the technology described in this specification.

In a design, the communication apparatus 1000 may be configured to perform functions of the AP MLD in Embodiment 2. The processor 1001 may be configured to generate a beacon frame sent in step S201 and generate a BTM request frame sent in step S203 in FIG. 18, and/or perform another process of the technology described in this specification. The transceiver 1002 may be configured to perform step S201 and step S203 in FIG. 18, and/or another process of the technology described in this specification.

In another design, the communication apparatus 1000 may be configured to perform functions of the first station in Embodiment 2. The processor 1001 may be configured to parse a beacon frame received in step S202 in FIG. 18 and parse a BTM request frame received in step S204, and/or perform another process of the technology described in this specification. The transceiver 1002 may be configured to perform step S202 and step S204 in FIG. 18, and/or another process of the technology described in this specification.

In a design, the communication apparatus 1000 may be configured to perform functions of the first device in Embodiment 3. The processor 1001 may be configured to perform step S301 in FIG. 20, and/or another process of the technology described in this specification. The transceiver 1002 may be configured to perform step S302 in FIG. 20, and/or another process of the technology described in this specification.

In another design, the communication apparatus 1000 may be configured to perform functions of the second device in Embodiment 3. The processor 1001 may be configured to perform step S304 in FIG. 20, and/or another process of the technology described in this specification. The transceiver 1002 may be configured to perform step S303 in FIG. 20, and/or another process of the technology described in this specification.

In a design, the communication apparatus 1000 may be configured to perform functions of the AP MLD in Embodiment 4. The processor 1001 may be configured to generate an SCS response frame sent in step S403 in FIG. 21, and/or perform another process of the technology described in this specification. The transceiver 1002 may be configured to perform step S403 and step S402 in FIG. 21, and/or another process of the technology described in this specification.

In another design, the communication apparatus 1000 may be configured to perform functions of the non-AP MLD in Embodiment 4. The processor 1001 may be configured to generate an SCS request frame sent in step S401 in FIG. 21, and/or perform another process of the technology described in this specification. The transceiver 1002 may be configured to perform step S401 and step S404 in FIG. 21, and/or another process of the technology described in this specification.

In a design, the communication apparatus 1000 may be configured to perform functions of the AP MLD in Embodiment 5. The processor 1001 may be configured to generate an SCS response frame sent in step S503 in FIG. 22, and/or perform another process of the technology described in this specification. The transceiver 1002 may be configured to perform step S503 and step S502 in FIG. 22, and/or another process of the technology described in this specification.

In another design, the communication apparatus 1000 may be configured to perform functions of the non-AP MLD in Embodiment 5. The processor 1001 may be configured to generate an SCS request frame sent in step S501 in FIG. 22, and/or perform another process of the technology described in this specification. The transceiver 1002 may be configured to perform step S501 and step S504 in FIG. 22, and/or another process of the technology described in this specification.

In any one of the foregoing designs, the processor 1001 may include a transceiver configured to implement sending and receiving functions. For example, the transceiver may be a transceiver circuit, an interface, or an interface circuit. The transceiver circuit, the interface, or the interface circuit configured to implement the receiving and sending functions may be separated, or may be integrated together. The transceiver circuit, the interface, or the interface circuit may be configured to read and write code/data. Alternatively, the transceiver circuit, the interface, or the interface circuit may be configured to transmit or transfer a signal.

In any one of the foregoing designs, the processor 1001 may store instructions. The instructions may be computer programs. When the computer programs are run on the processor 1001, the communication apparatus 1000 is enabled to perform the method described in any one of the foregoing method embodiments. The computer programs may be fixed in the processor 1001. In this case, the processor 1001 may be implemented by hardware.

In an implementation, the communication apparatus 1000 may include a circuit, and the circuit may implement a sending/receiving/communication function in the foregoing method embodiments. The processor and the transceiver described in the present disclosure may be implemented on an integrated circuit (IC), an analog IC, a radio frequency integrated circuit (RFIC), a mixed-signal IC, an application-specific integrated circuit (ASIC), a printed circuit board (PCB), an electronic device, or the like. The processor and the transceiver may alternatively be manufactured by using various IC technologies, for example, a complementary metal-oxide-semiconductor (CMOS), an N-channel metal-oxide-semiconductor (NMOS), a P-type metal-oxide-semiconductor (PMOS), a bipolar junction transistor (BJT), a bipolar CMOS (BiCMOS), silicon germanium (SiGe), and gallium arsenide (GaAs).

A scope of the communication apparatus described in the present disclosure is not limited thereto, and a structure of the communication apparatus may not be limited in FIG. 27. The communication apparatus may be an independent device or may be a part of a large device. For example, the communication apparatus may be: (1) an independent integrated circuit IC, a chip, or a chip system or subsystem; (2) a set including one or more ICs, where optionally, the set of ICs may also include a storage component configured to store data and a computer program; (3) an ASIC, for example, a modem; (4) a module that can be embedded in another device; (5) a receiver, a terminal, an intelligent terminal, a cellular phone, a wireless device, a handheld device, a mobile unit, a vehicle-mounted device, a network device, a cloud device, an artificial intelligence device, or the like; or (6) another device, or the like.

In a possible product form, the AP MLD, the first device, the non-AP MLD, the first station, and the second device in embodiments of the present disclosure may be implemented by a general-purpose processor.

A general-purpose processor for implementing the AP MLD includes a processing circuit and an input/output interface that is internally connected to and communicates with the processing circuit.

In a design, the general-purpose processor may be configured to perform functions of the AP MLD in Embodiment 1. Specifically, the processing circuit may be configured to perform step S101 in FIG. 15, and/or another process of the technology described in this specification. The input/output interface may be configured to perform step S102 in FIG. 15, and/or another process of the technology described in this specification.

In a design, the general-purpose processor may be configured to perform functions of the AP MLD in Embodiment 2. Specifically, the processing circuit may be configured to generate a beacon frame sent in step S201 and generate a BTM request frame sent in step S203 in FIG. 18, and/or perform another process of the technology described in this specification. The input/output interface may be configured to perform step S201 and step S203 in FIG. 18, and/or another process of the technology described in this specification.

In a design, the general-purpose processor may be configured to perform functions of the AP MLD in Embodiment 4. Specifically, the processing circuit may be configured to generate an SCS request frame sent in step S401 in FIG. 21, and/or perform another process of the technology described in this specification. The input/output interface may be configured to perform step S402 and step S403 in FIG. 21, and/or another process of the technology described in this specification.

In a design, the general-purpose processor may be configured to perform functions of the AP MLD in Embodiment 5. Specifically, the processing circuit may be configured to generate an SCS response frame sent in step S503 in FIG. 22, and/or perform another process of the technology described in this specification. The input/output interface may be configured to perform step S503 and step S502 in FIG. 22, and/or another process of the technology described in this specification.

A general-purpose processor for implementing the first device includes a processing circuit and an input/output interface that is internally connected to and communicates with the processing circuit. The general-purpose processor may be configured to perform functions of the first device in Embodiment 3. Specifically, the processing circuit may be configured to perform step S301 in FIG. 20, and/or another process of the technology described in this specification. The input/output interface may be configured to perform step S302 in FIG. 20, and/or another process of the technology described in this specification.

A general-purpose processor for implementing the non-AP MLD includes a processing circuit and an input/output interface that is internally connected to and communicates with the processing circuit.

In a design, the general-purpose processor may be configured to perform functions of the non-AP MLD in Embodiment 1. Specifically, the processing circuit may be configured to perform step S104 in FIG. 15, and/or another process of the technology described in this specification. The input/output interface may be configured to perform step S103 in FIG. 15, and/or another process of the technology described in this specification.

In a design, the general-purpose processor may be configured to perform functions of the non-AP MLD in Embodiment 4. Specifically, the processing circuit may be configured to generate an SCS request frame sent in step S401 in FIG. 21, and/or perform another process of the technology described in this specification. The input/output interface may be configured to perform step S401 and step S404 in FIG. 21, and/or another process of the technology described in this specification.

In a design, the general-purpose processor may be configured to perform functions of the non-AP MLD in Embodiment 5. Specifically, the processing circuit may be configured to generate an SCS request frame sent in step S501 in FIG. 22, and/or perform another process of the technology described in this specification. The input/output interface may be configured to perform step S501 and step S504 in FIG. 22, and/or another process of the technology described in this specification.

A general-purpose processor for implementing the first station includes a processing circuit and an input/output interface that is internally connected to and communicates with the processing circuit. The general-purpose processor may be configured to perform functions of the first station in Embodiment 2. Specifically, the processing circuit may be configured to parse a beacon frame received in step S202 and a BTM request frame received in step S204 in FIG. 18, and/or perform another process of the technology described in this specification. The input/output interface may be configured to perform step S202 and step S204 in FIG. 18, and/or another process of the technology described in this specification.

A general-purpose processor for implementing the second device includes a processing circuit and an input/output interface that is internally connected to and communicates with the processing circuit. The general-purpose processor is configured to perform functions of the second device in Embodiment 3. Specifically, the processing circuit may be configured to perform step S304 in FIG. 20, and/or another process of the technology described in this specification. The input/output interface may be configured to perform step S303 in FIG. 20, and/or another process of the technology described in this specification.

It should be understood that the communication apparatuses in the foregoing various product forms have any function of the device in any one of the foregoing embodiments.

An embodiment of the present disclosure further provides a computer-readable storage medium. The computer-readable storage medium stores computer program code. When the foregoing processor executes the computer program code, an electronic device performs the method in any one of the foregoing embodiments.

An embodiment of the present disclosure further provides a computer program product. When the computer program product runs on a computer, the computer is enabled to perform the method in any one of the foregoing embodiments.

An embodiment of the present disclosure further provides a communication apparatus. The apparatus may exist in a product form of a chip. A structure of the apparatus includes a processor and an interface circuit. The processor is configured to communicate with another apparatus through a receive circuit, so that the apparatus performs the method in any one of the foregoing embodiments.

An embodiment of the present disclosure further provides a wireless communication system, including an AP MLD and a non-AP MLD. The AP MLD and the non-AP MLD may perform any method in Embodiment 1, Embodiment 4, and Embodiment 5.

An embodiment of the present disclosure further provides a wireless communication system, including an AP MLD and a first station. The AP MLD and the first station may perform any method in Embodiment 2.

An embodiment of the present disclosure further provides a wireless communication system, including a first device and a second device. The first device and the second device may perform any method in Embodiment 3.

Method or algorithm steps described in combination with the content disclosed in the present disclosure may be implemented by hardware, or may be implemented by a processor by executing software instructions. The software instructions may include a corresponding software module. The software module may be stored in a random access memory (RAM), a flash memory, an erasable programmable read-only memory (ROM) (EPROM), an electrically erasable programmable ROM (EEPROM), a register, a hard disk, a removable hard disk, a compact disc ROM (CD-ROM), or any other form of storage medium well-known in the art. For example, a storage medium is coupled to a processor, so that the processor can read information from the storage medium and write information into the storage medium. Certainly, the storage medium may be a component of the processor. The processor and the storage medium may be disposed in an ASIC. In addition, the ASIC may be located in a core network interface device. Certainly, the processor and the storage medium may alternatively exist in the core network interface device as discrete components.

A person skilled in the art should be aware that in the foregoing one or more examples, functions described in the present disclosure may be implemented by hardware, software, firmware, or any combination thereof. When the functions are implemented by software, these functions may be stored in a computer-readable medium or transmitted as one or more instructions or code in a computer-readable medium. The computer-readable medium includes a computer-readable storage medium and a communication medium, where the communication medium includes any medium that enables a computer program to be transmitted from one place to another place. The storage medium may be any available medium accessible to a general-purpose or a special-purpose computer.

In the foregoing specific implementations, the objectives, the technical solutions, and the beneficial effect of the present disclosure are further described in detail. It should be understood that the foregoing descriptions are merely specific implementations of the present disclosure, but are not intended to limit the protection scope of the present disclosure. Any modification, equivalent replacement, improvement, or the like made based on the technical solutions of the present disclosure shall fall within the protection scope of the present disclosure.

What is claimed is:

1. A communication apparatus, comprising:
a processor, configured to generate a first frame comprising a supported rates and basic service set (BSS) membership selectors element, wherein the supported rates and BSS membership selectors element comprises first indication information indicating that a non-access point (AP) multi-link device (MLD) is disallowed from initiating a multi-link setup with the communication apparatus on a first link; and
a transceiver coupled to the processor and configured to send the first frame on the first link.

2. The communication apparatus of claim 1, wherein the transceiver is further configured to send, on a second link, a beacon frame or a probe response frame comprising a reduced neighbor report (RNR) element, wherein the RNR element comprises a neighbor AP information field corresponding to a first AP operating on the first link, and wherein the neighbor AP information field comprises a channel number field set to 0.

3. The communication apparatus of claim 1, wherein the first indication information further indicates that a single-link station supporting an Extremely High Throughput (EHT) protocol is disallowed from setting up an association with the communication apparatus on the first link.

4. The communication apparatus of claim 1, wherein the supported rates and BSS membership selectors element comprises a BSS membership selector, and wherein the first indication information is that the BSS membership selector is set to a preset value.

5. The communication apparatus of claim 1, wherein the first frame is a beacon frame, a probe response frame, an association response frame, or a reassociation response frame.

6. The communication apparatus of claim 1, wherein the first frame is an association response frame or a reassociation response frame, wherein the first frame further comprises a quality of service (QOS) map element, wherein the QoS map element comprises differentiated services code point (DSCP) range fields corresponding to eight different user priorities, wherein DSCP ranges indicated by the DSCP range fields corresponding to m user priorities in the eight different user priorities cover a DSCP space, wherein the DSCP space is an interval [0, 63], wherein m is a positive integer less than 8, and wherein DSCP low value fields and DSCP high value fields in the DSCP range fields corresponding to remaining (8−m) user priorities in the eight different user priorities are all set to 255.

7. The communication apparatus of claim 6, wherein after sending the first frame on the first link, the transceiver is further configured to:
receive a stream classification service (SCS) request frame comprising an SCS identifier field indicating an SCS stream; and
send an SCS response frame comprising a status code field indicating whether the communication apparatus accepts the SCS stream.

8. The communication apparatus of claim 7, wherein the SCS response frame further comprises, when the status code field indicates that the communication apparatus accepts the SCS stream, traffic identifier (TID)-to-link mapping element indicating a TID mapping rule.

9. The communication apparatus of claim 8, wherein the transceiver is further configured to send a data packet comprising a TID, and wherein the TID is set based on the QoS map element when the data packet does not match the SCS stream or the TID is set based on the TID-to-link mapping element when the data packet matches the SCS stream.

10. A communication apparatus, comprising:
a transceiver configured to receive a first frame on a first link, wherein the first frame comprises a supported rates and BSS membership selectors element, wherein the supported rates and BSS membership selectors element comprises first indication information indicating that the communication apparatus is disallowed from initiating a multi-link setup with an access point multi-link device (AP MLD) on the first link; and
a processor coupled to the transceiver and configured to parse the first frame to obtain the first indication information.

11. The communication apparatus of claim 10, wherein the transceiver is further configured to receive, on a second link, a beacon frame or a probe response frame comprising a reduced neighbor report (RNR) element, wherein the RNR element comprises a neighbor AP information field corresponding to a first AP operating on the first link in the AP MLD, and wherein the neighbor AP information field comprises a channel number field set to 0.

12. The communication apparatus of claim 10, wherein the first indication information further indicates that a single-link station supporting an Extremely High Throughput (EHT) protocol is disallowed from setting up an association with the AP MLD on the first link.

13. The communication apparatus of claim 10, wherein the supported rates and BSS membership selectors element comprises a BSS membership selector, and wherein the first indication information is that the BSS membership selector is set to a preset value.

14. The communication apparatus of claim 10, wherein the first frame is a beacon frame, a probe response frame, an association response frame, or a reassociation response frame.

15. The communication apparatus of claim 10, wherein the first frame is the association response frame or the reassociation response frame, wherein the first frame further comprises a quality of service (QOS) map element, wherein the QoS map element comprises differentiated services code point (DSCP) range fields corresponding to eight different user priorities, wherein DSCP ranges indicated by the DSCP range fields corresponding to m user priorities in the eight different user priorities cover DSCP space, wherein the DSCP space is an interval [0, 63], wherein m is a positive integer less than 8, and wherein DSCP low value fields and DSCP high value fields in the DSCP range fields corresponding to remaining (8−m) user priorities in the eight different user priorities are all set to 255.

16. The communication apparatus of claim 15, wherein after parsing the first frame, the transceiver is further configured to:
send a stream classification service (SCS) request frame comprising an SCS identifier field indicating an SCS stream; and
receive an SCS response frame comprising a status code field indicating whether the AP MLD accepts the SCS stream.

17. The communication apparatus of claim 16, wherein the SCS response frame further comprises, when the status code field indicates that the AP MLD accepts the SCS stream, a traffic identifier (TID)-to-link mapping element indicating a TID mapping rule.

18. The communication apparatus of claim 17, wherein the transceiver is further configured to send a data packet comprising a TID, and wherein the TID is set based on the QoS map element when the data packet does not match the SCS stream or the TID is set based on the TID-to-link mapping element when the data packet matches the SCS stream.

19. A method implemented by an access point (AP) multi-link device (MLD), comprising:
generating a first frame comprising a supported rates and basic service set (BSS) membership selectors element, wherein the supported rates and BSS membership selectors element comprises first indication information indicating that a non-AP MLD is disallowed from initiating a multi-link setup with the AP MLD on a first link; and
sending the first frame on the first link.

20. The method of claim 19, further comprising sending, on a second link, a beacon frame or a probe response frame comprising a reduced neighbor report (RNR) element, wherein the RNR element comprises a neighbor AP information field corresponding to a first AP operating on the first link, and wherein the neighbor AP information field comprises a channel number field set to 0.
